(19) United States
(12) Patent Application Publication
(10) Pub. No.: US 2026/0328341 A1
(43) Pub. Date: Oct. 22, 2026

(54) UNDERGROUND HYDROGEN STORAGE AND PRODUCTION VESSELS, INTEGRATED SYSTEMS THEREOF, AND METHODS THEREOF

(71) Applicant: SAUDI ARABIAN OIL COMPANY, Dhahran (SA)

(72) Inventors: Rima Taqi ALFARAJ, Dhahran (SA); Murtadha J. ALTAMMAR, Dhahran (SA); Ayman M. ALMOHSIN, Dhahran (SA)

(73) Assignee: SAUDI ARABIAN OIL COMPANY, Dhahran (SA)

(21) Appl. No.: 19/182,304

(22) Filed: Apr. 17, 2025

(51) Int. Cl. F17C 1/00; F17C 11/00

(52) U.S. Cl. CPC F17C 1/007; F17C 11/005; F17C 2221/012

(57) ABSTRACT

Underground hydrogen storage and production vessels and related integrated systems and methods. Underground hydrogen storage and production vessels include: a cased wellbore disposed in a subterranean formation, capable of storing hydrogen; one or more seals capable of fluidically isolating the cased wellbore from the subterranean formation; an injection wellhead for receiving hydrogen and injecting the received hydrogen into the cased wellbore; and a production wellhead for producing the stored hydrogen from the cased wellbore. The cased wellbore includes: a wellbore including a wellbore wall and a surface opening; a casing disposed within the wellbore, defining an interior and comprising an exterior surface and an interior surface; and at least one solid-state hydrogen storage material disposed in the interior of the casing, capable of reversibly storing the injected hydrogen, and including at least one material selected from the group consisting of metal hydrides, metal-organic frameworks, and any combination thereof.

### FIELD OF THE INVENTION

The present disclosure generally relates to underground hydrogen storage by use of solid-state hydrogen storage materials (SSHSMs). In particular, this disclosure describes underground hydrogen storage and production vessels disposed within cased wellbores and comprising SSHSMs.

### BACKGROUND

Hydrogen storage is a critical component of the emerging hydrogen economy, enabling the efficient and flexible use of hydrogen across various sectors and applications, such as energy systems, industrial processes, and transportation. Hydrogen can be produced from renewable energy sources, such as wind and solar, during periods of excess generation. Storing hydrogen allows this energy to be saved and used later when demand is higher or when renewable generation is low. This helps balance the grid and ensures a stable and reliable energy supply. Industrial processes which rely on hydrogen include steel production and chemical manufacturing. Hydrogen is also used as a fuel for fuel cell electric vehicles (FCEVs), and storing hydrogen at refueling stations and distribution centers ensures that there is an adequate supply to meet the needs of the transportation sector. Hydrogen storage may be used to provide a backup power supply for critical infrastructure, such as hospitals, data centers, and emergency services. In remote or off-grid locations, hydrogen storage can provide a reliable and clean energy source.

Hydrogen can be stored as a compressed gas, stored as liquid hydrogen, captured by hydrogen storage materials, or stored underground. Storing hydrogen underground offers several advantages, particularly for large-scale energy storage and distribution. Underground storage facilities, such as salt caverns, depleted oil and gas fields, and aquifers, can store vast quantities of hydrogen in the form of compressed hydrogen gas, generally at high pressures (as high as 700 bar). Underground storage can provide a safer environment for hydrogen, which is highly flammable and has a low ignition energy. Storing hydrogen underground reduces the risk of accidental release and exposure to atmospheric conditions that could lead to combustion. Once the initial infrastructure is in place, the operational costs of underground storage can be lower compared to aboveground storage options. Utilizing existing geological formations reduces the need for expensive containment structures and minimizes the environmental footprint compared to constructing new aboveground storage facilities. Geological formations can naturally accommodate the high pressures required for hydrogen storage, which can be more challenging and costly to achieve with aboveground storage tanks.

However, underground hydrogen storage does pose several challenges, including sufficient storage volume, hydrogen embrittlement, geological suitability, hydrogen purity, pressure and temperature management, and environmental impact. Hydrogen is a low-density molecule that, even when compressed, requires large storage volumes. Ensuring that a selected site can effectively contain sufficient volumes of hydrogen without leakage is essential. Hydrogen is a small molecule that can diffuse through materials more easily than other gases, posing a risk of leakage. Hydrogen is also highly reactive, which can cause embrittlement of metals and other materials used in storage infrastructure, such as pipelines, wells, and valves, leading to material degradation and potential failures.

Further, not all geological formations are located in proximity to hydrogen generation or hydrogen utilization facilities or are appropriate for storing hydrogen due to variations in permeability, porosity, structural integrity, or seismic activity. Underground storage formations may contain residual hydrocarbons, water, or other impurities that can contaminate the stored hydrogen. Implementing effective purification systems to remove contaminants from hydrogen after extraction can add complexity and cost to the storage process. Managing the pressure within the storage formation is essential to prevent over-pressurization, which can compromise the integrity of the storage site. Preventing temperature variations within the storage formation, which can affect the behavior of hydrogen and the storage formation, is also essential.

Therefore, a need exists for new underground storage technologies capable of long-term hydrogen storage while addressing these various challenges.

### BRIEF SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments in accordance with the present disclosure, underground hydrogen storage and production vessels comprise: a cased wellbore disposed within a subterranean formation and capable of storing hydrogen; one or more seals capable of fluidically isolating the cased wellbore from the subterranean formation; an injection wellhead in fluid communication with the cased wellbore and capable of receiving hydrogen and injecting the received hydrogen into the cased wellbore; and a production wellhead in fluid communication with the cased wellbore and capable of producing the stored hydrogen from the cased wellbore, wherein the production wellhead and the injection wellhead are the same wellhead or different wellheads, wherein the cased wellbore comprises: a wellbore comprising a wellbore wall and a surface opening; a casing disposed within the wellbore, defining an interior and comprising an exterior surface and an interior surface; and at least one solid-state hydrogen storage material disposed in the interior of the casing, capable of reversibly storing the injected hydrogen, and comprising at least one material selected from the group consisting of metal hydrides, metal-organic frameworks, and any combination thereof.

According to further embodiments in accordance with the present disclosure, integrated underground hydrogen storage and production systems comprise: one or more underground hydrogen storage and production vessels, each comprising: a cased wellbore disposed within a subterranean formation and capable of storing hydrogen; one or more seals capable of fluidically isolating the cased wellbore from the subterranean formation; an injection wellhead in fluid communication with the cased wellbore, the injection wellhead capable of receiving hydrogen and injecting the received hydrogen into the cased wellbore; and a production wellhead in fluid communication with the cased wellbore, the production wellhead capable of producing the stored hydrogen from the cased wellbore, wherein the production wellhead and the injection wellhead are the same wellhead or different wellheads, wherein the cased wellbore comprises: a wellbore comprising a wellbore wall and a surface opening; a casing disposed within the wellbore, defining an interior and comprising an exterior surface and an interior surface; and at least one solid-state hydrogen storage material disposed in the interior of the casing, capable of reversibly storing the injected hydrogen, and comprising at least one material selected from the group consisting of metal hydrides, metal-organic frameworks, and any combination thereof; one or more hydrogen generation systems, each capable of generating hydrogen and sending the generated hydrogen directly or indirectly to at least one of the injection wellheads of the one or more underground hydrogen storage and production vessels; and one or more hydrogen utilization systems, each capable of directly or indirectly receiving hydrogen produced from at least one of the production wellheads of the one or more underground hydrogen storage and production vessels and utilizing the received hydrogen as a fuel or to generate electricity.

According to further embodiments in accordance with the present disclosure, methods of underground hydrogen storage and production comprise: injecting hydrogen into an underground hydrogen storage and production vessel via an injection wellhead thereof; storing the injected hydrogen in the underground hydrogen storage and production vessel; and producing the stored hydrogen from the underground hydrogen storage and production vessel via a production wellhead thereof; wherein the underground hydrogen storage and production vessel comprises; a cased wellbore disposed within a subterranean formation and capable of storing hydrogen; one or more seals capable of fluidically isolating the cased wellbore from the subterranean formation; the injection wellhead in fluid communication with the cased wellbore, the injection wellhead capable of receiving hydrogen and injecting the received hydrogen into the cased wellbore; and the production wellhead in fluid communication with the cased wellbore, the production wellhead capable of producing the stored hydrogen from the cased wellbore, wherein the production wellhead and the injection wellhead are the same wellhead or different wellheads; and wherein the cased wellbore comprises: a wellbore comprising a wellbore wall and a surface opening; a casing disposed within the wellbore, defining an interior and having an exterior surface and an interior surface; and at least one solid-state hydrogen storage material (SSHSM) disposed in the interior of the casing, capable of reversibly storing the injected hydrogen, and comprising at least one material selected from the group consisting of metal hydrides, metal-organic frameworks (MOFs), and any combination thereof.

Any combinations of the various embodiments and implementations disclosed herein can be used in a further embodiment, in accordance with the present disclosure. These and other aspects and features can be appreciated from the following description of certain embodiments presented herein in accordance with the present disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a theorized underground hydrogen storage and production vessel utilizing a storage pipe placed within a decommissioned wellbore (Salmachi et al., 2022).

FIG. 2 illustrates a theorized underground hydrogen storage and production vessel utilizing a storage pipe placed within a decommissioned wellbore which has been sealed with a double plug cement seal (Salmachi et al., 2022).

FIG. 3 illustrates an integrated underground hydrogen storage and production system utilizing one or more vertical wellbores as underground hydrogen storage and production vessels, the vertical wellbores drilled at one or more shallow depths, each using a single wellhead to inject and produce hydrogen, in accordance with one embodiment.

FIG. 4 illustrates an integrated underground hydrogen storage and production system utilizing one or more horizonal wellbores, such as L-shaped wellbores, as underground hydrogen storage and production vessels, the horizontal wellbores drilled at one or more shallow depths, each using a single wellhead to inject and produce hydrogen, in accordance with one embodiment.

FIG. 5 illustrates an integrated underground hydrogen storage and production system utilizing one or more U-shaped wellbores as underground hydrogen storage and production vessels, the U-shaped wellbores using separate injection and production wellheads, in accordance with one embodiment.

### DETAILED DESCRIPTION

The present disclosure generally relates to underground hydrogen storage and production vessels comprising solid-state hydrogen storage materials (SSHSMs) disposed within cased wellbores, integrated underground hydrogen storage and production systems thereof, and methods of underground hydrogen storage and production thereof. In particular, this disclosure describes underground hydrogen storage and production vessels comprising SSHSMs disposed within cased wellbores, the SSHSMs capable of reversibly storing hydrogen.

Accordingly, the present disclosure generally relates to underground hydrogen storage and production vessels, comprising: a cased wellbore disposed within a subterranean formation and capable of storing hydrogen; one or more seals capable of fluidically isolating the cased wellbore from the subterranean formation; an injection wellhead in fluid communication with the cased wellbore, the injection wellhead capable of receiving hydrogen and injecting the received hydrogen into the cased wellbore; and a production wellhead in fluid communication with the cased wellbore, the production wellhead capable of producing the stored hydrogen from the cased wellbore, wherein the production wellhead is a same or different wellhead as the injection wellhead, wherein the cased wellbore comprises: a wellbore comprising a wellbore wall and at least one surface opening; a casing disposed within the wellbore, the casing defining an interior and having an exterior surface and an interior surface; and at least one SSHSM disposed in the interior of the casing, capable of reversibly storing the injected hydrogen, and comprising at least one material selected from the group consisting of metal hydrides, MOFs, and any combination thereof.

The present disclosure further relates to integrated underground hydrogen storage and production systems comprising: one or more underground hydrogen storage and production vessels of the present disclosure; one or more hydrogen generation systems, each capable of generating hydrogen and sending the generated hydrogen directly or indirectly to at least one of the injection wellheads of the one or more underground hydrogen storage and production vessels; and one or more hydrogen utilization systems, each capable of directly or indirectly receiving hydrogen produced from at least one of the production wellheads of the one or more underground hydrogen storage and production vessels and utilizing the received hydrogen as a fuel or to generate electricity.

The present disclosure further relates to methods of underground hydrogen storage and production comprising: injecting hydrogen into an underground hydrogen storage and production vessel of the present disclosure via an injection wellhead thereof; storing the injected hydrogen in the underground hydrogen storage and production vessel; and producing the stored hydrogen from the underground hydrogen storage and production vessel via a production wellhead thereof.

### Underground Hydrogen Storage and Production Vessels

In one aspect, underground hydrogen storage and production vessels comprise a cased wellbore disposed within a subterranean formation and capable of storing hydrogen; one or more seals capable of fluidically isolating the cased wellbore from the subterranean formation; an injection wellhead in fluid communication with the cased wellbore and capable of receiving hydrogen and injecting the received hydrogen into the cased wellbore; and a production wellhead in fluid communication with the cased wellbore and capable of producing the stored hydrogen from the cased wellbore (production wellhead), wherein the production wellhead and the injection wellhead are the same wellhead or different wellheads. The cased wellbore may comprise: a wellbore comprising a wellbore wall and at least one surface opening; a casing disposed within the wellbore, the casing defining an interior and having an exterior surface and an interior surface; and at least one SSHSM capable of reversibly storing the injected hydrogen, disposed in the interior of the casing and comprising at least one material selected from the group consisting of metal hydrides, MOFs, and any combination thereof.

Traditional hydrogen storage relies on storage containers, such as storage pipes, to store hydrogen as compressed hydrogen gas or as liquid hydrogen. The hydrogen gas storage capacity of such storage pipes is limited by the number of storage pipes and the length and diameter of these storage pipes. However, underground hydrogen storage vessels of the present disclosure contain at least one hydrogen storage material disposed therein. Hydrogen storage materials of the present disclosure may be capable of adsorbing hydrogen at a greater hydrogen density than the density of liquid hydrogen (~70.8 kg/m³ at 20K (the boiling point of hydrogen) and atmospheric pressure), allowing, for example, the use of shorter sections of cased wellbores to store the same amount of hydrogen compared to the same cased wellbores in the absence of such hydrogen storage materials. While most SSHSMs, such as MOFs, will perform well at cryogenic temperatures (e.g., ~77K), certain SSHSMs, such as metal hydrides (e.g., metal borohydrides) or more advanced MOFs, such as MOFs doped with catalysts, may be selected which perform well at room temperature (e.g., ~298K) or greater, reducing or eliminating the need to employ supplemental cooling systems.

Underground hydrogen storage and production vessels of the present disclosure further contain one or more seals which isolate the cased wellbores from the subterranean formation, thereby preventing leakage of hydrogen out of, and flow of subterranean formation fluids into, the underground hydrogen storage and production vessels. Accordingly, storage pipes are unnecessary in properly sealed underground hydrogen storage and production vessels filled with SSHSMs. The SSHSMs will store hydrogen within the casing itself, provided that an annulus between the wellbore wall and the outer surface of the casing is properly isolated using cement sheaths and/or other seals. In comparison, storing conventional compressed hydrogen within a wellbore may require an internal pipe, but SSHSMs eliminate this requirement by acting as the storage medium in the wellbore itself.

### Solid-State Hydrogen Storage Materials (SSHSMs)

SSHSMs may include various solid materials capable of reversibly storing large quantities of hydrogen via various binding (i.e., sorption) mechanisms and various releasing (i.e., desorption) mechanisms. Sorption can lead to adsorption or absorption, depending upon the location of sorbed species (also referred to herein as the “sorbent”), such as in the bulk (i.e., absorption) vs. at a surface or interface (i.e., adsorption). Adsorption may be physical adsorption (also referred to herein as “physisorption”) or chemical adsorption (also referred to herein as “chemisorption”). Suitable SSHSMs may be highly porous materials comprising high hydrogen storage capacity, high surface area, and a range of pore sizes. A review of solid-state hydrogen storage materials is provided by Sarker, M. N., Sakib, A. N., Al-Mobin, M. I. H., and Resnick, P. M. “Innovative Materials and Techniques for Enhancing Hydrogen Storage: A Comprehensive Review of Damage Detection and Preventive Strategies.” ASME Open J. Engineering ASME. January 2024).

SSHSMs may be characterized by their hydrogen storage capacity. Gravimetric hydrogen storage capacity may be expressed either as hydrogen weight percent (wt. %) ([mass of hydrogen]/[mass of sample +mass of hydrogen]) or as a hydrogen weight ratio (mg g⁻¹, i.e., [mass of hydrogen in milligrams (mg)]/[mass of SSHSM in grams (g)]). Volumetric hydrogen storage capacity may be expressed as a hydrogen weight/volume ratio (g L⁻¹, i.e., [mass of hydrogen in grams (g)]/[volume of SSHSM in liters (L)]). Hydrogen storage capacity may be determined by neutron powder diffraction (NPD), or the like.

Suitable SSHSMs may have a gravimetric hydrogen storage capacity ranging from about a 1 wt. % to about a 2 wt. %, where a 1 and a 2 may be, independently, 3 wt. %, 4 wt. %, 5 wt. %, 6 wt. %, 7 wt. %, 8 wt. %, or greater, and where a 1<a2. For example, SSHSMs may have a gravimetric hydrogen storage capacity of about 3 wt. % to about 8 wt. %, or about 3 wt. % to about 7 wt. %, or about 3 wt. % to about 6 wt. %, or about 3 wt. % to about 5 wt. %, or about 3 wt. % to about 4 wt. %, or about 4 wt. % to about 8 wt. %, or about 4 wt. % to about 7 wt. %, or about 4 wt. % to about 6 wt. %, or about 4 wt. % to about 5 wt. %, or about 5 wt. % to about 8 wt. %, or about 5 wt. % to about 7 wt. %, or about 5 wt. % to about 6 wt. %, or about 6 wt. % to about 8 wt. %, or about 6 wt. % to about 7 wt. %, or about 7 wt. % to about 8 wt. %.

SSHSMs may be characterized by their surface area. SSHSMs may exhibit a wide range of surface areas, which significantly influences their hydrogen adsorption capacities. The specific surface area is typically measured using nitrogen adsorption isotherms at 77K and calculated via the Brunauer-Emmett-Teller (BET) equation. Suitable SSHSMs may have a BET surface area ranging from about b1 m²/g to about b2 m²/g, where b1 and b2 may be, independently, 1,000 m²/g, 1,500 m²/g, 2,000 m²/g, 2,500 m²/g, 3,000 m²/g, 3,500 m²/g, 4,000 m²/g, 4,500 m²/g, 5,000 m²/g, or greater, and where b1<b2. For example, SSHSMs may exhibit a BET surface area of about 1,000 m²/g to about 5,000 m²/g, or about 1,000 m²/g to about 4,000 m²/g, or about 1,000 m²/g to about 3,000 m²/g, or about 1,000 m²/g to about 2,000 m²/g, or about 2,000 m²/g to about 5,000 m²/g, or about 2,000 m²/g to about 4,000 m²/g, or about 2,000 m²/g to about 3,000 m²/g, or about 3,000 m²/g to about 5,000 m²/g, or about 3,000 m²/g to about 4,000 m²/g, or about 4,000 m²/g to about 5,000 m²/g.

SSHSMs may be characterized in terms of their pore size. Suitable SSHSMs may include micropores, mesopores, macropores and any combination thereof. Micropores are defined herein as having a pore size of about 2 nm (20 Angstrom (Å)) in diameter or below. Micropores may be further classified into ultramicropores (smaller than about 0.7 nm (7 Å)) and supermicropores (0.7 nm (7 Å) to 2 nm (20 Å). Mesopores are defined herein as having a pore size from about 2 nm (20 Å) in diameter to about 50 nm (500 Å) in diameter. Macropores are defined herein as having a pore size larger than 50 nm (500 Å) in diameter. Interparticle textural porosity may be present in some instances. Determination of microporosity, mesoporosity, and/or interparticle textural porosity may be determined by analysis of the nitrogen adsorption isotherm at 77K, as will be understood by one having ordinary skill in the art. Suitable SSHSMs may have an average pore size ranging from about c1 nm to about c2 nm, where c1 and c2 may be, independently, 0.5 nm, 0.6 nm, 0.7 nm, 0.75 nm, 0.8 nm, 0.9, 1.0 nm, 1.1 nm, 1.2 nm, 1.25 nm, 1.3 nm, 1.4 nm, 1.5 nm, 1.6 nm, 1.7 nm, 1.75 nm, 1.8 nm, 1.8 nm, 2 nm, or greater, and where c1<c2. For example, SSHSMs may have an average pore size of about 0.5 nm to about 2.0 nm, or about 0.5 nm to about 1.75 nm, or about 0.5 nm to about 1.5 nm, or about 0.5 nm to about 1.25 nm, or about 0.5 nm to about 1.0 nm, or about 0.5 nm to about 0.75 nm, or about 0.75 to about 2.0 nm, or about 0.75 nm to about 1.75 nm, or about 0.75 nm to about 1.5 nm, or about 0.75 nm to about 1.25 nm, or about 0.75 nm to about 1.0 nm, or about 1.0 nm to about 2 nm, or about 1.0 nm to about 1.75 nm, or about 1.0 nm to about 1.5 nm, or about 1.0 nm to about 1.25 nm, or about 1.25 nm to about 2.0 nm, or about 1.25 nm to about 1.75 nm, or about 1.25 nm to about 1.5 nm, or about 1.5 nm to about 2.0 nm, or about 1.5 nm to about 1.75 nm, or about 1.75 nm to about 2.0 nm. A key consideration in selecting suitable SSHSMs is to select materials with flexible pores and/or tailored functionalization to improve hydrogen uptake at moderate temperatures.

SSHSMs may be characterized in terms of their physical form. Suitable SSHSMs may include at least one material in the form of a powder, a pellet, a single crystal, a thin film, a fiber, a monolith, a composite, or any combination thereof. SSHSMs may be present in cased wellbores in bulk form. Particularly when used in bulk form, suitable SSHSMs may be selected from materials exhibiting robust thermal conductivity to manage pressure and temperature gradients within the cased wellbore. In certain embodiments, SSHSMs may be integrated with thermally conductive supports (e.g., graphene or carbon nanotubes), particularly for horizontal wellbores, such as U-shaped wellbores. SSHSMs may be present in cased wellbores in combination with support materials to provide high surface area (e.g., carbon nanotubes or silica supports) to achieve enhanced hydrogen absorption and release kinetics. SSHSMs may be a composite (e.g., the SSHSMs may be embedded in a matrix, such as a polymeric matrix), which may enhance mechanical stability and handling but reduce overall hydrogen storage capacity. Suitable SSHSMs combined with high surface area supports and/or embedded in a matrix may have enhanced thermal conductivity and/or may be combined with a high thermal conductivity support for optimal performance.

SSHSMs may be characterized in terms of their packing arrangement in the interior of a casing. SSHSMs may be packed to fill a majority of or all of the interior of the casing and may be packed as densely as possible, while still allowing hydrogen movement. However, the specific packing method and density will depend on the material's form (e.g., powder, pellets, monoliths) and the required permeability for hydrogen transport. A completely dense pack may limit gas flow, so structured packing or engineered voids or conduits may be needed. A structured packing (pellets or monolithic structures with gas channels) can ensure efficient adsorption and desorption while maintaining permeability. Horizontal wells may require an axial void or central perforated tube to facilitate hydrogen transport through the entire length of the wellbore. SSHSMs can be packed using several methods: pelletized form (allows for structured stacking with controlled porosity); granular or powder form (provides high packing density but may require stabilizing agents or a binder); monoliths or composite forms (can integrate thermally conductive supports (e.g., carbon nanotubes)) to improve heat management; embedded in a matrix (can enhance mechanical stability but may reduce total hydrogen storage capacity). Engineered gaps or conduits are recommended to ensure hydrogen can move efficiently from the injection wellhead through the casing to the production wellhead. Options include: central perforated pipe or axial flow channel (prevents flow resistance and ensures uniform hydrogen distribution); segmented packing with void spaces (ensures consistent adsorption and desorption rates); horizontal/U-shaped well considerations (thermally conductive materials (e.g., graphene-enhanced supports)) may be required to prevent localized heating during hydrogen cycling.

### Chemisorption SSHSMs

Chemisorption processes involve chemical bonding (e.g., strong interactions) between hydrogen molecules (i.e., the adsorbate) and an SSHSM (i.e., the adsorbent) via chemical bonding, particularly formed between the adsorbate as a monolayer on the adsorbent surface. The main advantage of such chemisorption SSHSMs is the reasonable temperatures (e.g., below 300° C. and below 200 bar) required to load these materials with hydrogen, but their limitation is the reduced reversibility due to high activation energy, requiring high dehydrogenation temperatures. Suitable examples of chemisorption SSHSMs include metal hydrides (e.g., metal borohydrides), metal nitrides, metal imides, and the like. In certain embodiments, suitable metal hydrides comprise metal borohydrides, nanoporous metal hydrides, or any combination thereof.

### Metal Hydrides

Metal hydrides suitable for hydrogen storage may include metal hydrides of transition metals, such as magnesium hydride (MgH₂) or titanium hydride (TiH₂), hydrides of rare earth metals, such as lanthanum hydride (LaH₂), metal hydrides of other metals, such as calcium hydride (CaH₂) or lithium hydride (LiH), and the like.

Suitable metal hydrides may include intermetallic hydrides. Intermetallic hydrides may include AB5-type hydrides, based on alloys such as LaNi₅, which can absorb and desorb hydrogen at moderate temperatures and pressures, such as LaNi₅H₆ (~1.4 wt. % hydrogen storage near ambient conditions with mild heating). Intermetallic hydrides may include AB2-type hydrides including alloys like TiFe₂ and ZrMn₂, which also show good hydrogen storage properties, including TiFeH₂ and ZrMn₂H₃. Intermetallic hydrides may include AB-type hydrides including TiFeH₂, which store hydrogen at relatively low pressure and temperature (~1.9 wt. % hydrogen storage near ambient conditions with mild heating).

Suitable metal hydrides may include complex hydrides, such as alanates and metal borohydrides. Alanates are hydrides of aluminum, e.g., sodium alanate (NaAlH₄) and lithium alanate (LiAlH₄), having high hydrogen storage capacities but require catalysts to release hydrogen at practical temperatures. Metal borohydrides, such as lithium borohydride (LiBH₄), sodium borohydride (NaBH₄), and magnesium borohydride (Mg(BH₄)₂), have very high hydrogen storage capacity but require high temperatures for hydrogen release.

Suitable metal hydrides may have a gravimetric hydrogen storage capacity ranging from about d1 wt. % to about d2 wt. %, where d1 and d2 may be, independently, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, or greater, and where d1<d2. For example, metal hydrides may have a gravimetric hydrogen storage capacity of about 3 wt. % to about 8 wt. %, or about 3 wt. % to about 7 wt. %, or about 3 wt. % to about 6 wt. %, or about 3 wt. % to about 5 wt. %, or about 3 wt. % to about 4 wt. %, or about 4 wt. % to about 8 wt. %, or about 4 wt. % to about 7 wt. %, or about 4 wt. % to about 6 wt. %, or about 4 wt. % to about 5 wt. %, or about 5 wt. % to about 8 wt. %, or about 5 wt. % to about 7 wt. %, or about 5 wt. % to about 6 wt. %, or about 6 wt. % to about 8 wt. %, or about 6 wt. % to about 7 wt. %, or about 7 wt. % to about 8 wt. %. In certain embodiments, metal hydrides have gravimetric hydrogen storage capacities of about 3 wt. % to about 8 wt. %. Some of the most suitable SSHSMs for room-temperature operations may include complex hydrides (e.g., NaAlH₄ or Mg(BH₄)₂) and emerging nanoconfined hydrides that exhibit improved desorption kinetics. For example, magnesium hydride (MgH₂) stores 7.6 wt. % but requires temperatures of about 300 °C for hydrogen release, while NaAlH₄ can reversibly store 4-5 wt. % at 150 °C, 100 bar.

### Metal Borohydrides

Suitable examples of chemisorption SSHSMs may include metal borohydride materials, which can store hydrogen at ambient or near-ambient temperatures by chemical binding of hydrogen. Suitable metal borohydrides may include light metal borohydrides, where the light metal is selected from the group consisting of lithium, potassium, magnesium, aluminum, titanium, or any combination thereof.

While metal borohydrides generally possess increased hydrogen storage capacity, their high thermal stability can hinder their hydrogen release kinetics. See Liu, Jianjun and Ma, Yong and Yang, Jinggang and Sun, Lei and Guo, Dongliang and Xiao, Peng, “Recent advance of metal borohydrides for hydrogen storage,” Frontiers in Chemistry, 10:945208 (2022), doi.org/10.3389/fchem.2022.945208. These materials generally require specific conditions to release hydrogen, such as elevated temperatures (e.g., >250°C for magnesium hydride; lithium borohydride (LiBH₄), having a melting point around 278 °C, begins significant hydrogen desorption at >380°C). Further, after hydrogen release, metal borohydrides may form stable decomposition products, such as elemental boron, which may impede the material's ability to reabsorb hydrogen without additional processing. Thus, while these compounds offer high gravimetric hydrogen storage capacities, reduced hydrogen desorption and post-desorption reactions may decrease the practical hydrogen yield. LiBH₄, for instance, has a theoretical hydrogen capacity of 18.5 wt. %, though practical desorption yields about 13.8 wt. % under certain conditions. Additionally, many metal borohydrides are highly sensitive to moisture and can react vigorously with water, necessitating handling in controlled environments to prevent hydrolysis.

Suitable metal borohydrides may include nanoporous metal borohydrides having improved hydrogen absorption/desorption kinetics, but which still operate at moderate temperatures and pressures. See Liu et al., 2022; see also Rude, L. H., Nielsen, T. K., Ravnsbæk, D. B., Bösenberg, U., Ley, M. B., Richter, B., Arnbjerg, L. M., Dornheim, M., Filinchuk, Y., Besenbacher, F. and Jensen, T. R., “Tailoring properties of borohydrides for hydrogen storage: A review”. Phys. Status Solidi A, 208:1754-1773 (2011).doi.org/ 10.1002/pssa.201001214. Suitable nanoporous borohydrides may include nanoporous magnesium borohydrides, including α-Mg(BH₄)₂, β-Mg(BH₄)₂, γ-Mg(BH₄)₂, γ-Mg(BH₄)₂-0.80 H₂, or δ-Mg(BH₄)₂, as described by Filinchuk, Yaroslav and Richter, Bo and Jensen, Torben R. and Dmitriev, Vladimir and Chernyshov, Dmitry and Hagemann, Hans, “Inside Cover: Porous and Dense Magnesium Borohydride Frameworks: Synthesis, Stability, and Reversible Absorption of Guest Species.” Angew. Chemie Int. Ed. 50/47(2011): 11014-11014, doi. org/ 10.1002/anie.201106052, and as further described by Hyunchul Oh, Nikolay Tumanov, Voraksmy Ban, Xiao Li, Bo Richter, Matthew R. Hudson, Craig M. Brown, Gail N. Iles, Dirk Wallacher, Scott W. Jorgensen, Luke Daemen, Rafael Balderas-Xicohténcatl, Yongqiang Cheng, Anibal J. Ramirez-Cuesta, Michael Heere, Sergio Posada-Pérez, Geoffroy Hautier, Michael Hirscher, Torben R. Jensen, and Yaroslav Filinchuk, “Small-pore hydridic frameworks store densely packed hydrogen.” Nature Chemistry 16 (2024): 809:816, doi.org/10.1038/s41557-024-01443-x.

Suitable metal borohydrides may have a gravimetric hydrogen storage capacity ranging from about e1 wt. % to about e2 wt. %, where e1 and e2 may be, independently, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, or greater, and where e1<e2. For example, metal borohydrides may have a gravimetric hydrogen storage capacity of about 3 wt. % to about 22 wt. %, or about 5 wt. % to about 20 wt. %, or about 7 wt. % to about 18 wt. %, or about 9 wt. % to about 16 wt. %, or about 11 wt. % to about 14 wt. %, or about 4 wt. % to about 21 wt. %, or about 6 wt. % to about 19 wt. %, or about 8 wt. % to about 17 wt. %, or about 10 wt. % to about 15 wt. %, or about 12 wt. % to about 13 wt. %, or about 5 wt. % to about 22 wt. %, or about 7 wt. % to about 20 wt. %, or about 9 wt. % to about 18 wt. %, or about 11 wt. % to about 16 wt. %, or about 13 wt. % to about 15 wt. %, or about 6 wt. % to about 21 wt. %, or about 8 wt. % to about 19 wt. %, or about 10 wt. % to about 17 wt. %, or about 12 wt. % to about 15 wt. %, or about 7 wt. % to about 22 wt. %, or about 9 wt. % to about 20 wt. %, or about 11 wt. % to about 18 wt. %, or about 13 wt. % to about 16 wt. %, or about 8 wt. % to about 21 wt. %, or about 10 wt. % to about 19 wt. %, or about 12 wt. % to about 17 wt. %, or about 14 wt. % to about 15 wt. %, or about 9 wt. % to about 22 wt. %, or about 11 wt. % to about 20 wt. %, or about 13 wt. % to about 18 wt. %, or about 15 wt. % to about 16 wt. %, or about 10 wt. % to about 21 wt. %, or about 12 wt. % to about 19 wt. %, or about 14 wt. % to about 17 wt. %, or about 11 wt. % to about 22 wt. %, or about 13 wt. % to about 20 wt. %, or about 15 wt. % to about 18 wt. %, or about 12 wt. % to about 21 wt. %, or about 14 wt. % to about 19 wt. %, or about 16 wt. % to about 17 wt. %, or about 13 wt. % to about 22 wt. %, or about 15 wt. % to about 20 wt. %, or about 17 wt. % to about 18 wt. %, or about 14 wt. % to about 21 wt. %, or about 16 wt. % to about 19 wt. %, or about 15 wt. % to about 22 wt. %, or about 17 wt. % to about 20 wt. %, or about 16 wt. % to about 21 wt. %, or about 17 wt. % to about 22 wt. %, or about 19 wt. % to about 20 wt. %, or about 18 wt. % to about 21 wt. %, or about 19 wt. % to about 22 wt. %, or about 20 wt. % to about 21 wt. %, or about 21 wt. % to about 22 wt. %. In certain embodiments, metal borohydrides have gravimetric hydrogen storage capacities of about 14 wt. % to about 22 wt. %. Suitable metal borohydrides may have a volumetric hydrogen storage capacity greater than 70.8 g/L, which is the density of liquid hydrogen. In certain embodiments, metal borohydrides have volumetric hydrogen storage capacities of about 80 g/L or greater. In certain embodiments, metal borohydrides have gravimetric hydrogen storage capacities of about 80 g/L to about 150 g/L or greater.

Suitable metal borohydrides may have an average pore diameter ranging from about f1 Å to about f2 Å, where f1 and f2 may be, independently, 0.6 Å, 0.7 Å, 0.8 Å, 0.9 Å, 1 Å, 2 Å, 3 Å, 4 Å, 5 Å, 6 Å, 7 Å, 8 Å, 9 Å, 10 Å, 11 Å, or 12 Å, or greater, and where f1<f2. For example, metal borohydrides may have an average pore diameter of about 0.6 Å to about 12 Å, or about 0.6 Å to about 10 Å, or about 0.6 Å to about 8 Å, or about 0.6 Å to about 6 Å, or about 0.6 Å to about 4 Å, or about 0.6 Å to about 2 Å, or about 0.6 Å to about 1 Å, or about 0.8 Å to about 12 Å, or about 0.8 Å to about 10 Å, or about 0.8 Å to about 8 Å, or about 0.8 Å to about 6 Å, or about 0.8 Å to about 4 Å, or about 0.8 Å to about 2 Å, or about 0.8 Å to about 1 Å, or 1 Å to about 12 Å, or about 1 Å to about 10 Å, or about 1 Å to about 8 Å, or about 1 Å to about 6 Å, or about 1 Å to about 4 Å, or about 1 Å to about 2 Å, or about 2 Å to about 12 Å, or about 2 Å to about 10 Å, or about 2 Å to about 8 Å, or about 2 Å to about 6 Å, or about 2 Å to about 4 Å, or about 4 Å to about 12 Å, or about 4 Å to about 10 Å, or about 4 Å to about 8 Å, or about 4 Å to about 6 Å, or about 6 Å to about 12 Å, or about 6 Å to about 10 Å, or about 6 Å to about 8 Å, or about 8 Å to about 12 Å, or about 8 Å to about 10 Å, or about 10 Å to about 12 Å. Suitable metal borohydrides may have an average pore diameter of about 6 Å (0.6 nm) to about 12 Å (1.2 nm), covering variations in polymorph structures while maintaining dense hydrogen storage capacity. In certain embodiments, suitable metal borohydrides have an average pore diameter of about 6 Å, such as the smaller ultramicropores in certain magnesium borohydride structures, facilitating strong hydrogen adsorption. In certain embodiments, suitable metal borohydrides have an average pore diameter of about 9 Å, such as the Oh et al., 2024 γ-Mg(BH₄)₂ polymorphs. In certain embodiments, suitable metal borohydrides have an average pore diameter of about 12 Å, including the slightly larger pores found in expanded forms of Mg(BH₄)₂, which provide better diffusion properties while maintaining high storage densities. These values are in alignment with studies on nanoporous metal borohydrides, ensuring both high volumetric and gravimetric hydrogen capacities while optimizing hydrogen diffusion.

Suitable metal borohydrides may have a BET surface area (nitrogen or hydrogen) of about 1,200 m²/g to about 2,600 m²/g at 20K. In certain embodiments, suitable metal borohydrides, such as γ-Mg(BH₄)₂ polymorphs, may have a BET surface area (nitrogen or hydrogen isotherm) of about 1200 m²/g to about 1800 m²/g at 20K, while certain alkali metal borohydride mixtures have reported surface areas up to 2,587 m²/g.

### Physisorption SSHSMs

Physisorption processes involve adsorption of hydrogen molecules onto the surface of pores of porous materials via intermolecular forces (e.g., weak van der Waals forces). Physical adsorption is a reversible process involving no activation energy and having a very low interaction energy. Thus, suitable hydrogen storage materials may be materials capable of hydrogen physisorption. The main advantage of such porous SSHSMs are fast absorption/desorption kinetics, but their limitation is low storage capacities at ambient temperature and pressure. Suitable examples of physisorption SSHSMs include MOFs, carbon-based materials (e.g., carbon aerogels, activated carbon, and the like), zeolites, and the like.

### Metal-Organic Frameworks (MOFs)

Suitable examples of physisorption SSHSMs may include metal-organic frameworks (also referred to herein as “MOFs”). MOFs are a relatively new class of highly porous materials with potential applications in a wide range of fields. MOFs comprise multidentate organic ligands that function as “struts” or “scaffolding” that bridge between metal atoms or clusters of metal atoms, which collectively define an extended coordination structure having uniform pores defined therein. The pore size and pore distribution of MOFs is typically defined by the molecular size and ligating topology of the organic ligands, as well as the coordination geometry of the metal atom(s) defining the MOF structure. The pore size and pore distribution of MOFs may be tuned through selection of the multidentate organic ligands and the metal atom(s) (metal ions or metal clusters) used to construct the MOF. However, most reported MOFs are classified as microporous.

Because organic ligands may be readily modified, MOFs as a whole exhibit a great breadth of structural diversity (e.g., different cage structures), much more so than that found for other porous materials, such as zeolites. A given cage topology may be realized with several related organic ligands and/or different metal ions, but the size and distribution of the resulting pores may differ somewhat depending on the specific organic ligands and metal ions used to construct the MOF. In some cases, even small changes in the structure of the organic ligand and/or the metal may result in MOFs having various and differing topologies, including different crystalline phases.

By virtue of their highly porous character, MOFs may incorporate a variety of molecules (adsorbates) within their pore structure. Factors governing whether a particular adsorbate will be incorporated within the pores of a given MOF may include, for example, hydrophobicity or hydrophilicity of the adsorbate in comparison to that of the pores, the molecular size of the adsorbate with respect to the size and geometry of the pores, and ability of the adsorbate to access the pores.

MOFs offer several advantages for hydrogen storage. Their high porosity allows for a large amount of hydrogen to be stored within a relatively small volume, increasing the storage capacity. Additionally, the adsorption and desorption of hydrogen in MOFs can occur at near-ambient temperatures and moderate pressures, making them potentially suitable for practical applications. A review of MOFs which have been developed for hydrogen storage may be found in Suh, Myunghyun Paik; Park, Hye Jeong; Prasad, Thazhe Kootteri; and Lim, Dae-Woon, “Hydrogen Storage in Metal-Organic Frameworks.” Chemical Reviews, Vol. 112, No. 2(2012), pages 782-835, and may further be found in Peng, Peng; Jiang, Henry Z. H.; Collins, Stephanie; Furukawa, Hiroyasu; Long, Jeffrey R.; and Breunig, Hanna, “Long Duration Energy Storage Using Hydrogen in Metal-Organic Frameworks: Opportunities and Challenges.” ACS Energy Letters, Vol. 9, No. 6, May 14, 2024).

MOFs also generally exhibit high thermal stability, with some structures stable up to 300 °C. The pore size and functionality of MOFs can be precisely controlled through the selection of metal nodes and organic linkers, allowing for tailored properties for specific applications. MOFs possess exceptionally high porosity, with pore volumes that can exceed those of traditional porous materials, facilitating significant gas storage capacities. Due to their tunable pore environments, MOFs can be designed for selective adsorption of specific gases, enhancing their efficiency in applications like gas separation and purification. These properties make MOFs promising candidates for hydrogen storage and other gas adsorption applications.

For hydrogen storage at cryogenic temperatures, a suitable MOF may include, e.g., MOF-210, which stores up to 17.6 wt. % at 77K and 80 bar. A particularly suitable MOF exhibiting superior volumetric and gravimetric hydrogen storage capacity may include MOF-5, a benchmark high performance MOF, or IRMOF-20, a MOF shown to have hydrogen storage capacity even greater than MOF-5. See Ahmed, Alauddin and Liu, Yiyang and Purewal, Justin and Tran, Ly D. and Wong-Foy, Antek G. and Veenstra, Mike and Matzger, Adam J. and Siegel, Donald J. “Balancing gravimetric and volumetric hydrogen density in MOFs.” Energy & Environmental Science, vol. 10, no. 11, Jan. 2017. doi.org/10.1039/c7ee02477k. Benchmark MOF-5 (or IRMOF-1) is a cubic MOF with the formula Zn₄O(BDC)₃, where BDC²⁻=1,4-benzodicarboxylate (MOF-5). MOF-5 is notable for exhibiting one of the highest surface area to volume ratios among MOFs, at 2200 m²/cm³. IRMOF-20 is isoreticular with MOF-5, with the same Zn-based secondary building units (SBUs), but with a sulfur(S) heteroatom-containing linker. IRMOF-20 was demonstrated to have a usable gravimetric hydrogen storage capacity of 5.7 wt. % at 77K with a pressure swing between 5 and 100 bar and a usable volumetric hydrogen storage capacity of 33.4 g/L under the same conditions. These values indicate that while some MOFs approach the density of liquid hydrogen (70.8 g/L), achieving such high volumetric capacities remains challenging, particularly at higher working temperatures. Typical MOFs store only about 1-2 wt. % of hydrogen at room temperature at high pressures (~100 bar).

Hydrogen storage capacity of MOFs may be alternately increased by doping MOFs with catalysts such as palladium (Pd) or platinum (Pt). Suitable examples of catalyst-doped MOFs may include palladium (Pd) nanoparticle doped MOF HKUST-1, which shows ~1.6 wt. % hydrogen storge capacity at 298K under high pressure (~18 MPa). See Hu, Xiaoyu and Wang, Jinchuan and Li, Shangkun and Hu, Xuanhao and Ye, Rongxing and Zhou, Linsen and Li, Peilong and Chen, Changlun, “Pd-doped HKUST-1 MOFs for enhanced hydrogen storage: effect of hydrogen spillover,” RSC Adv., 2023, 13:22, pp. 14980-14990, doi.org/10.1039/D3RA01788E.

Alternatively, hydrogen storage above ambient temperatures may be achieved using defective framework MOFs. As used herein, the terms “defective framework MOFs” or “de-MOFs” refer to MOFs which have been modified, such as by annealing, to form linker vacancies, while retaining some crystal properties of the original MOF. In certain embodiments, an original MOF is MOF-74. See Tong Xiao and Dingxin Liu, “The most advanced synthesis and a wide range of applications of MOF-74 and its derivatives,” Microporous and Mesoporous Materials, Volume 283, (2019), 88-103, doi.org/10.1016/j. micromeso.2019.03.002. “Among all MOFs, MOF-74 which is also called CPO-27, M₂(dobdc) or M₂(dhtp), consisting of transition-metal cations (M) (M=Zn²⁺, Mg²⁺, Co²⁺, Cd²⁺, Mn²⁺, Fe²⁺, or Ni²⁺) and the organic ligand dobdc⁴⁻ (2,5-dioxido-1,4-benzenedicarboxylate) or dhtp⁴⁻ (2,5-dihydroxyterephthalate . . . ) is a very unique and critical one. In the structure of MOF-74, a one dimensional [MO-COOXu-OH]ₙ chain is constructed into a three-dimensional honeycomb structure, forming a one dimensional hexagon channel network in which one metal cation is bonded to five O. Metal ions and ligands form straight infinite helical secondary building units.” Id.

An example of a suitable defective framework MOF-74 may include, for example a defective Mg-MOF-74 (de-MgMOF), as described by Liu et al., 2024 (Shiyuan Liu, Yue Zhang, Fangzhou Zhu, Jieyuan Liu, Xin Wan, Ruonan Liu, Xiaofang Liu, Jia-Xiang Shang, Ronghai Yu, Qiang Feng, Zili Wang, and Jianglan Shui, “Mg-MOF-74 Defective Framework for Hydrogen Storage at Above-Ambient Temperature Assisted by Pt Catalyst,” Advanced Science, Volume 11,No. 18, May 15, 2024.) “Mg-MOF-74 has hexagonal channels, in which Mg atoms are positioned at vertex positions in a zigzag manner, and each Mg atom coordinates with five O atoms (MgO₅ sites) and dangles a DMF or H₂O guest molecule.” Id. page 2. The defective MOF (de-MgMOF) was prepared by “mild annealing of Mg-MOF-74 in Ar/H₂ (95%/5%), which creates a substantial number of linker vacancies while retaining some crystal properties of the original MOF. The resultant coordinatively unsaturated MgO₅ knots near these vacancies present strong hydrogen adsorption strength, elevating the hydrogen adsorption temperature of de-MfMOF to much above ambient levels.” Id. “These knots have much higher adsorption strength than their desolvated counterparts, leading to high working temperatures of 200-300 °C With the assistance of a spillover catalyst (Pt) to reduce the operation temperature to an appropriate level, the material of Pt-de-MgMOF exhibits a remarkable hydrogen storage capability of 2.6 wt. % at 160 °C.” Id. page 6. Thus, suitable MOFs may be both defective framework MOFs and catalyst doped MOFs, to increase both hydrogen storage capability and to increase operating temperature of the MOFs. In certain embodiments, suitable MOFs comprise defective MOFs, catalyst-doped MOFs, or any combination thereof.

Suitable MOFs may have a gravimetric hydrogen storage capacity ranging from about g1 wt. % to about g2 wt. %, where g1 and g2 may be, independently, 4.5 wt. %, 4.6 wt. %, 4.7 wt. %, 4.8 wt. %, 4.9 wt. %, 5 wt. %, 5.1 wt. %, 5.2 wt. %, 5.3 wt. %, 5.4 wt. %, 5.5 wt. %, 5.6 wt. %, 5.7 wt. %, 5.8 wt. %, 5.9 wt. %, 6.0 wt. %, 6.1 wt. %, 6.2 wt. %, 6.3 wt. %, 6.4 wt. % or 6.5 wt. %, or greater, and where g1<g2. For example, MOFs may have a gravimetric hydrogen storage capacity of about 4.5 wt. % to about 6.1 wt. %, or about 4.5 wt. % to about 5.7 wt. %, or about 5.7 wt. % to about 6.1 wt. %, or greater.

Suitable MOFs may have a volumetric hydrogen storage capacity greater than 70.8 g/L, which is the density of liquid hydrogen. In certain embodiments, suitable MOFs may have a volumetric hydrogen storage capacity ranging from about h1 g/L to about h2 g/L, where h1 and h2may be, independently, 31 g/L, 31.1 g/L, 32 g/L, 33 g/L, 34 g/L, 35 g/L, 35.5 g/L, 36 g/L, or greater, and where h1<h2. For example, MOFs may have a volumetric hydrogen storage capacity of about 31 g/L to about 36 g/L, or about 31.1 g/L to about 35.5 g/L, or about 32 g/L to about 35 g/L, or about 33 g/L to about 34 g/L.

Suitable MOFs may have an average pore diameter ranging from i1 Å to i2 Å, wherein i1 and i2 may be, independently, 5 Å, 5.2 Å, 10 Å, 14 Å, 15 Å, 20 Å, 25 Å, 30 Å, 35 Å, 40 Å, 45 Å, 50 Å, 55 Å, 60 Å, 65 Å, 70 Å, 75 Å, 80 Å, 85 Å, 90 Å, 95 Å, or 98 Å, where i1<i2. For example, suitable MOFs may have an average pore diameter of about 5 Å to about 98 Å, or about 5.2 Å to about 98 Å, or about 10 Å to about 98 Å, or about 14 Å to about 98 Å. In certain embodiments, suitable MOFs have an average pore diameter of at least about 14 Å, e.g., the IRMOF-74 series, which demonstrates pore apertures ranging from 14 Å to 98 Å, depending on the length of the organic linker used. MOFs are among the materials with the highest surface areas, often exceeding 3,000 m²/g. For instance, MOF-177 has a specific surface area of approximately 4,500 m²/g when measured at 77K using nitrogen adsorption. Suitable MOFs may have a BET surface area (nitrogen or hydrogen) ranging from j1 to j2 at 20K, where j1 and j2 may be, independently, 1,000 m²/g, 2,000 m²/g, 3,000 m²/g, 4,000 m²/g, 5,000 m²/g, 6,000 m²/g, 7,000 m²/g, 8,000 m²/g, 9,000 m²/g, or 10,000 m²/g, or greater, where j1<j2. For example, suitable MOFs may have a BET surface area of about 1,000 m²/g to about 10,000 m²/g, or about 1,000 m²/g to about 8,000 m²/g, or about 1,000 m²/g to about 6,000 m²/g, or about 1,000 m²/g to about 4,000 m²/g, or about 1,000 m²/g to about 2,000 m²/g, or about 2,000 m²/g to about 9,000 m²/g, or about 2,000 m²/g to about 7,000 m²/g, or about 2,000 m²/g to about 5,000 m²/g, or about 2,000 m²/g to about 3,000 m²/g, or about 3,000 m²/g to about 10,000 m²/g, or about 3,000 m²/g to about 8,000 m²/g, or about 3,000 m²/g to about 6,000 m²/g, or about 3,000 m²/g to about 4,000 m²/g, or about 4,000 m²/g to about 9,000 m²/g, or about 4,000 m²/g to about 7,000 m²/g, or about 4,000m 2 /g to about 5,000m 2 /g, or about 5,000 m²/g to about 10,000 m²/g, or about 5,000 m²/g to about 8,000 m²/g, or about 5,000 m²/g to about 7,000 m²/g, or about 6,000 m²/g to about 9,000 m²/g, or about 6,000 m²/g to about 7,000 m²/g, or about 7,000 m²/g to about 10,000 m²/g, or about 7,000 m²/g to about 8,000 m²/g, or about 8,000 m²/g to about 9,000 m²/g, or about 9,000 m²/g to about 10,000 m²/g, at 20K.

In certain embodiments, suitable MOFs may have a BET surface area (nitrogen or hydrogen isotherm) of about 7,000 m²/g to about 10,000 m²/g at 20K. Two MOFs designated NU-109 and NU-110 have exhibited BET surface areas of 7,000 m²/g. See Farha, Omar K. and Eryazici, Ibrahim and Jeong, Nak Cheon and Hauser, Brad G. and Wilmer, Christopher E. and Sarjeant, Amy A. and Snurr, Randall Q. and Nguyen, SonBinh T. and Yazaydin, A. “Metal-Organic Framework Materials with Ultrahigh Surface Areas: Is the Sky the Limit?,” Journal of the American Chemical Society, 2012, 134:36, pp. 15016-15021, doi.10.1021/ja3055639. In comparison, activated carbons (ACs) also demonstrate substantial surface areas. Materials prepared from polypyrrole precursors treated with KOH have exhibited surface areas ranging from 3,000 to 3,500 m²/g, with corresponding hydrogen storage capacities of up to 7.03 wt. % Å at 77K and 20 bar. Further, zeolites, which are microporous crystalline aluminosilicates, typically have lower surface areas compared to MOFs and activated carbons. Their surface areas can reach up to 1,000 m²/g.

### Cased Wellbores

Cased wellbores suitable for use in underground hydrogen storage and production vessels may comprise a wellbore disposed within a subterranean formation and having a wellbore wall and at least one surface opening. Wellbores may have various wellbore geometries, depending on the location and storage capacity requirements. Wellbores may be a vertical wellbore or a horizontal wellbore. Horizontal wellbores may have a horizontal wellbore section which has a horizontally straight path (i.e., a 90° inclination with a vertical wellbore section) (e.g., an L-shaped wellbore or a U-shaped wellbore) or which deviates from a horizontally straight path (e.g., an L-shaped directional wellbore or a U-shaped directional wellbore). A vertical wellbore, an L-shaped wellbore, or an L-shaped directional wellbore may comprise a single surface opening, while a U-shaped wellbore or a U-shaped directional wellbore may comprise two surface openings.

Cased wellbores may have a casing disposed within the wellbore, the casing defining an interior, and comprising an interior surface and the outside surface. At least one SSHSM of the present disclosure may be disposed within the interior of the casing. The underground hydrogen storage and production vessel may allow hydrogen to be sequentially injected into, stored within, and produced from the casing comprising the at least one SSHSM.

When it comes to underground hydrogen storage in cased wellbores, maintaining good integrity is critical to long-term safe and efficient operation. When manufacturing the casing, it is important to consider the specific requirements of the underground hydrogen storage system, such as pressure limits, temperature ranges, and safety regulations. The casing design should meet these specifications and ensure long-term durability and integrity under the intended operating conditions. Hydrogen absorption improves at higher pressures, requiring casing materials rated for the intended pressure range (e.g., 50-200 bar or higher).

Common steel casings are not generally suitable for traditional hydrogen storage in cased wellbores (i.e., in the absence of the at least one SSHSM) due to several critical concerns, including hydrogen embrittlement, permeability, and corrosion. Hydrogen can diffuse into the steel and weaken its atomic bonds, making it brittle and prone to cracking, especially under pressure. Traditional steel casings are not perfectly impermeable to hydrogen, which can lead to gradual leakage over time. Hydrogen can react with certain elements in steel, such as sulfur, to create corrosive compounds that can damage the casing.

Suitable casings for use in underground hydrogen storage and production vessels of the present disclosure may contain at least one SSHSM which is less susceptible to the escape of hydrogen from the cased wellbore, allowing for the maximum retention of the stored hydrogen gas. Hydrogen-resistant materials may minimize the escape of hydrogen from the cased wellbore by preventing hydrogen diffusion through the material. Hydrogen-resistant material may bind hydrogen, thereby preventing the detrimental reaction between hydrogen and the casing, which would otherwise weaken the casing and allow greater amounts of hydrogen from being released from the cased wellbore. Suitable casings may comprise: at least one hydrogen-resistant material; a coating comprising at least one hydrogen-resistant material; and/or an internal liner comprising at least one hydrogen-resistant material, wherein the at least one hydrogen-resistant material comprises a thermoplastic polymer, a fiber-reinforced composite thereof, a metal alloy, or any combination thereof. Below are some examples of suitable casing materials for hydrogen storage in cased wellbores, which particularly address the known limitations of common steel.

Suitable casings may include traditional metal casings, such as steel casings or aluminum alloy casings, having a hydrogen-resistant coating. Hydrogen-resistant coatings may be applied directly to the surfaces of the metal casings. Hydrogen-resistant coatings may include polymer coatings, such as thermoplastic polymer coatings, as described herein, ceramic coatings, such as aluminum oxide or zirconium oxide coatings, nickel-phosphorous coatings, or metal alloy coatings. Coated metal casings may be prepared by cladding or spraying a traditional metal casing with a nickel or chromium alloy to enhance hydrogen resistance, but coating integrity may need to be monitored, and cost can be a factor. Examples of hydrogen-resistant coated metal casings may include stainless steel casings (e.g., 316L or duplex grades) with an anti-corrosion polymer coating or a ceramic coating.

Suitable casings may include traditional metal casings, composite casings, or non-metallic casings, when used in combination with hydrogen-resistant internal liners. Hydrogen-resistant internal liners may be made of polymers, such as thermoplastic polymers (e.g., polyethylene (PE), particularly high-density polyethylene (HDPE) or polypropylene (PP) or fluoropolymers, particularly polytetrafluoroethylene (PTFE)), which may provide an effective barrier against hydrogen embrittlement and permeation, but may be susceptible to mechanical damage and require careful installation.

Suitable casings may include metallic or non-metallic casings made of hydrogen-resistant materials. Suitable metallic casings may include casing made of oxidation-and corrosion-resistant alloys, such as Inconel (a nickel-chromium-based superalloy) and other nickel-based alloys. Examples of suitable grades of corrosion-resistant alloys include Inconel Alloy 625. Suitable non-metallic casings may include casings made from fiber-reinforced polymers (FRPs), such as carbon fiber-reinforced polymers (CFRPs), which offer high strength, low weight, and excellent hydrogen resistance. However, their long-term performance in downhole environments and cost-effectiveness are still under evaluation. Non-metallic casings may also include casings made of thermoplastic polymers, such as from HDPE or PVC or polyamides or fluoropolymers (e.g., PTFE), which can be suitable for low-pressure hydrogen storage. However, they may have limitations in terms of temperature resistance and mechanical strength for deeper wellbores. Other thermoplastic polymers suitable as casings may include enhanced UHMWPE Ultra-High Molecular Weight Polyethylene, a type of thermoplastic polymer known for its exceptional strength, high abrasion resistance, and low coefficient of friction. UHMWPE has a very high molecular weight, which gives it unique mechanical and chemical properties. It is lightweight, resistant to chemicals and impact, and has excellent self-lubricating properties.

### Seals

The underground hydrogen storage and production vessel may be sealed with one or more seals to prevent hydrogen gas loss, which is critical, as hydrogen has a low molecular weight and can permeate through small gaps or porous materials. By maintaining reliable seals, the escape of hydrogen from the underground hydrogen storage and production vessel is minimized, allowing for the maximum retention of the stored hydrogen gas. A well-sealed underground hydrogen storage and production vessel contributes to its overall hydrogen storage efficiency. By minimizing hydrogen gas losses, the underground hydrogen storage and production vessel can maintain a higher concentration and quantity of stored hydrogen, optimizing the available storage capacity. This helps to ensure that the stored hydrogen is readily available for utilization when needed, enhancing the operational efficiency of the underground hydrogen storage and production vessel, as well as integrated underground hydrogen storage and production systems thereof. Further, properly sealing the underground hydrogen storage and production vessel prevents hydrogen from being released into the environment, reducing the potential impact on air quality and greenhouse gas emissions. By securely storing hydrogen, the environmental benefits associated with its use as a clean energy carrier can be maximized. Suitable seals may comprise at least one hydrogen-resistant material. Suitable hydrogen-resistant materials may include hydrogen-resistant casing materials which are the same as or different from those described herein for use as a casing material.

In certain embodiments, the one or more seals may be disposed at one or more openings of the underground hydrogen storage and production vessel, and/or within portions of the subterranean formation adjacent to the underground hydrogen storage and production vessel. In certain embodiments, the one or more openings of the underground hydrogen storage and production vessel may comprise perforations in the casing, the bottom opening of the casing of a vertical wellbore, the opening of the casing at the casing toe (i.e., at the end of the horizontal wellbore section) of an L-shaped wellbore or an L-shaped directional wellbore, and/or an annulus between the wellbore wall and the outer surface of the casing. In certain embodiments, the one or more seals may comprise seals covering and/or filling perforations in the casing. In certain embodiments, the one or more seals may comprise seals disposed in portions of the subterranean formation, such as portions adjacent to perforations in a casing, portions adjacent to the bottom opening of a vertical casing, or portions adjacent to the opening at the casing toe of a horizontal wellbore section.

In certain embodiments, the one or more seals may comprise a seal (e.g., a cement sheath) disposed in the annulus. Suitable materials for forming an annular seal will be understood by one having ordinary skill in the art. A cement sheath in cased wellbores may serve as a barrier to prevent fluid migration between the subterranean formation and the wellbore. However, its effectiveness in resisting hydrogen leakage is influenced by several factors: hydrogen diffusion, cement integrity, and chemical reactivity. Due to hydrogen's small molecular size and high diffusivity, it can permeate through the cement matrix. Studies indicate that hydrogen can fully penetrate a 35 cm thick cement sheath in approximately 7.5 days under typical well conditions. See Dudun A, Feng Y, and Guo B., “Numerical Simulation of Hydrogen Diffusion in Cement Sheath of Wells Used for Underground Hydrogen Storage,” Sustainability, 2023; 15(14): 10844. doi.org/10.3390/su151410844. Further, exposure to hydrogen can alter the physical properties of cement. Experimental results have shown increases in permeability and porosity of cement samples after hydrogen exposure, potentially facilitating leakage pathways. See Maury Fernandez, D., Emadi, H., Thiyagarajan, S., Hussain, A., and I. Ispas. “Effects of Hydrogen on Class H Well Cement's Properties Under Geological Storage Conditions.” Paper presented at the 57th U.S. Rock Mechanics/Geomechanics Symposium, Atlanta, Georgia, USA, June 2023. doi.org/10.56952/ARMA-2023-0735. Finally, while hydrogen does not significantly react with certain wellbore cements (See Aftab A, Hassanpouryouzband A, Martin A, Kendrick J E, Thaysen E M, Heinemann N, Utley J, Wilkinson M, Haszeldine R S, Edlmann K. “Geochemical Integrity of Wellbore Cements during Geological Hydrogen Storage.” Environ Sci Technol Lett. 2023 June 25; 10(7): 551-556. doi: 10.1021/acs. estlett.3c00303. PMID: 37455863; PMCID: PMC 10339721), its diffusion can still compromise the mechanical integrity of the cement sheath over time. While the cement sheath provides an initial barrier against hydrogen migration, its resistance to hydrogen leakage is not absolute, and can diminish in effectiveness over time. Therefore, additional measures, such as selecting low-porosity and/or hydrogen resistant cements, ensuring complete cement hydration, and incorporating supplementary seals elsewhere in the underground hydrogen storage and production vessel, are recommended to enhance the barrier's performance against hydrogen leakage. In certain embodiments, the one or more seals are disposed in portions of the subterranean formation in fluid communication with the wellbore wall, the cement sheath, the outer surface of the casing, and/or one of the openings in the casing. The one or more seals may inhibit flow of hydrogen out of the cased wellbore during storage therein.

Suitable seals may comprise mechanical seals (i.e., pre-formed seals, e.g., plugs or patches) or chemical seals (e.g., formed in-situ by chemical reaction of a precursor material). Suitable mechanical seals may comprise at least one material selected from the group consisting of polymers, composites, metals, cements, or the like, or any combination thereof. Suitable chemical seals may comprise at least one precursor material selected from the group consisting of monomers, polymers, cements, crosslinking agents, or the like, or any combination thereof. In certain example embodiments, a precursor material is a solidifying composition. The precursor material may comprise a gel composition, such as polyacrylamide gels, nanosilica gels, or the like, or any combination thereof. In certain embodiments, the gel composition may be a liquid composition comprising a crosslinking agent capable of delayed triggering of solidification of the liquid composition into a gel. In certain embodiments, the gel composition may comprise additives for thermal stability. In certain embodiments, the gel composition may have enhanced sealing properties at high temperatures and pressures, such as subterranean temperatures and pressures. In certain embodiments, the colloidal nanosilica gel composition comprises an organosilane-modified colloidal silica and a crosslinking agent, as disclosed by U.S. Pat. No. 11,104,838, incorporated by reference herein in its entirety. Colloidal nanosilica gel compositions are particularly suitable for use as a sealing agent for storage of hydrogen within underground hydrogen storage and production vessels of the present disclosure, as minimal interaction is expected to occur between the colloidal nanosilica gel compositions with SSHSMs, and the colloidal nanosilica gel compositions would act as an effective sealing agent for any unadsorbed compressed hydrogen gas present therein. In certain embodiments, casings comprising chemically inert metals/alloys/polymers or having chemically inert coatings or liners are used to enhance the resistance of the casing to any detrimental interaction with the colloidal nanosilica gel composition.

Suitable materials useful to double plug larger openings in the casing (e.g., at the end of the wellbore), and/or portions of the subterranean formation adjacent to such openings, may include either mechanical seals or chemical seals, even chemical seals comprising more viscous precursors as described herein, such as a cement. This technique helps to maintain wellbore integrity by adding extra structural support to the wellbore which reduces the likelihood of leaks. However, lower viscosity chemical seals as described herein, such as crosslinkable nanosilica gel, may be particularly suitable materials for plugging smaller openings in a casing (e.g., perforations along the length of a casing, or the like) and/or portions of the subterranean formation adjacent to such openings. Replacement of perforated casings in existing wellbores or the insertion of a storage pipe within the interior of the casing may not be required when such low viscosity chemical seals are used to plug these perforations and/or portions of the subterranean formation adjacent to these perforations as described herein.

### Injection and Production Wellheads

Wellheads, including injection wellheads and production wellheads, may be in fluid communication with the cased wellbore, e.g., disposed at or near one of the surface openings of the wellbore. An injection wellhead may be in fluid communication with the cased wellbore for receiving hydrogen and injecting hydrogen into the cased wellbore. A production wellhead may be in fluid communication with the cased wellbore for producing hydrogen from the cased wellbore and delivering hydrogen for subsequent use. A production wellhead may be the same or a different wellhead as the injection wellhead. Underground hydrogen storage and production vessels comprising a vertical wellbore, a directional wellbore, or an L-shaped wellbore (or an L-shaped directional wellbore) may use a single wellhead operating as the injection wellhead and the production wellhead. Underground hydrogen storage vessels comprising a U-shaped wellbore (or a U-shaped directional wellbore) may use a first wellhead operating as the injection wellhead and a second wellhead operating as the production wellhead.

### Integrated Underground Hydrogen Storage and Production Systems

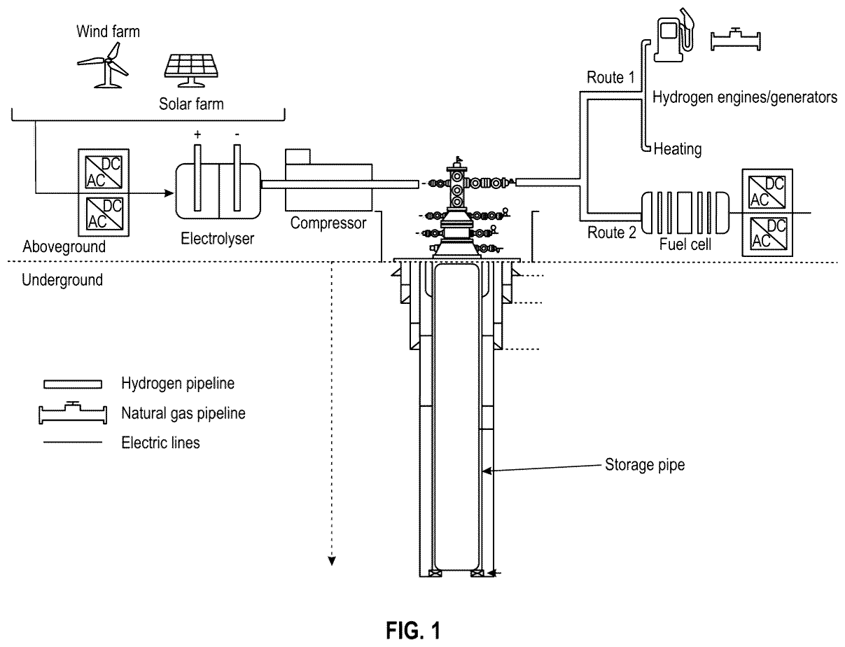

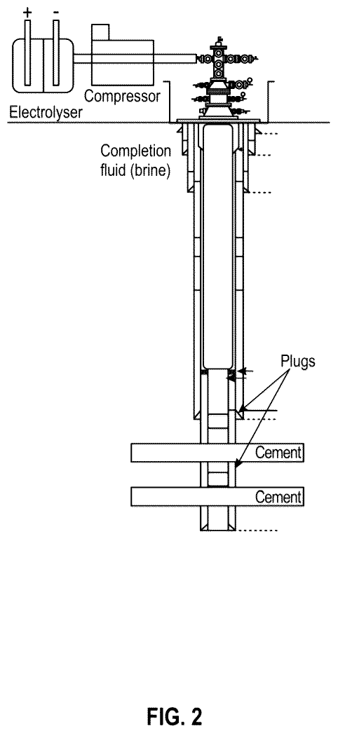

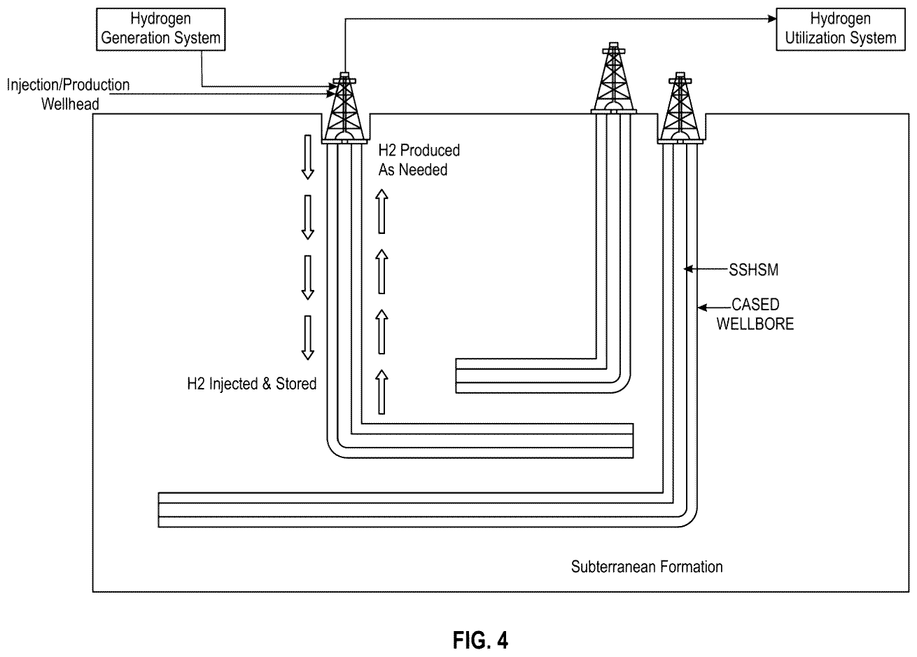

Integrated underground hydrogen storage and production systems of the present disclosure may comprise a network of interconnected systems and processes to generate, store, produce, and utilize hydrogen. Integrated underground hydrogen storage and production systems may comprise underground hydrogen storage and production vessels (e.g., comprising underground hydrogen storage and production vessels of the present disclosure), various means for generating hydrogen for storage within the underground hydrogen storage and production vessels, as well as various means to produce hydrogen from the underground hydrogen storage and production vessels when desired. FIG. 1 illustrates a theorized method of pipe storage of hydrogen in a decommissioned wellbore (see Abstract. FIG. 2: Alireza Salmachi, Tara Hosseini, Raheel Ahmed Shaikh, Alex Dinovitser, Derek Abbott, “Techno-economic assessment of hydrogen pipe storage in decommissioned wellbores sourced from surplus renewable electricity,” International Journal of Hydrogen Energy, Volume 47, Issue 56, 2022, pages 23710-23720). Green hydrogen, produced by surplus renewable electricity, is compressed and stored in the gaseous form in a storage pipe secured within the wellbore. The hybrid system allows hydrogen to be used either directly as a fuel or converted back to electricity using a fuel cell. FIG. 2 (see FIG. 4: Salmachi et al., 2022) further illustrates the proposed method of pipe storage of hydrogen in a decommissioned wellbore, where the decommissioned wellbore is sealed from below with a double plug cement seal.

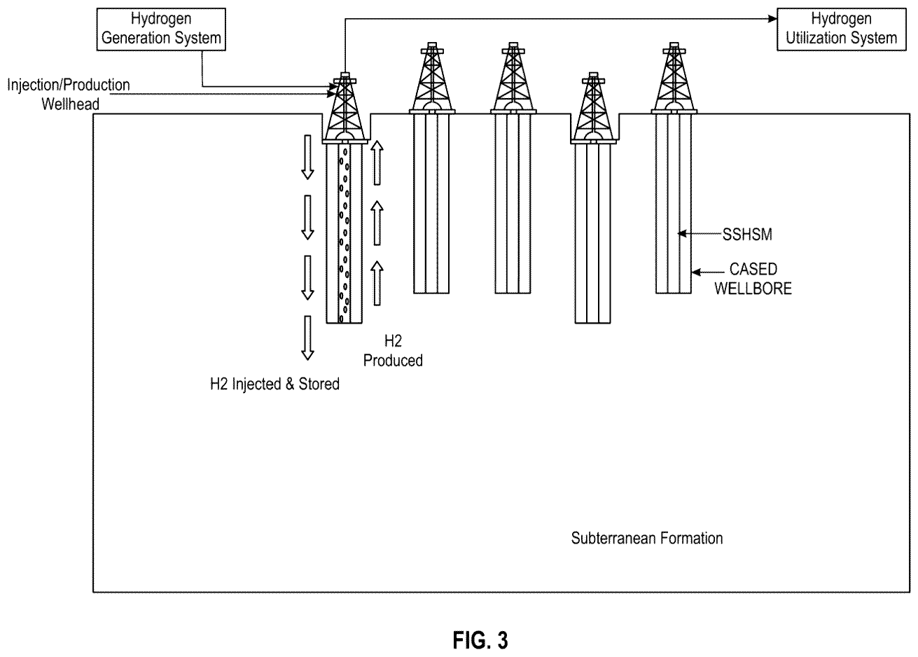

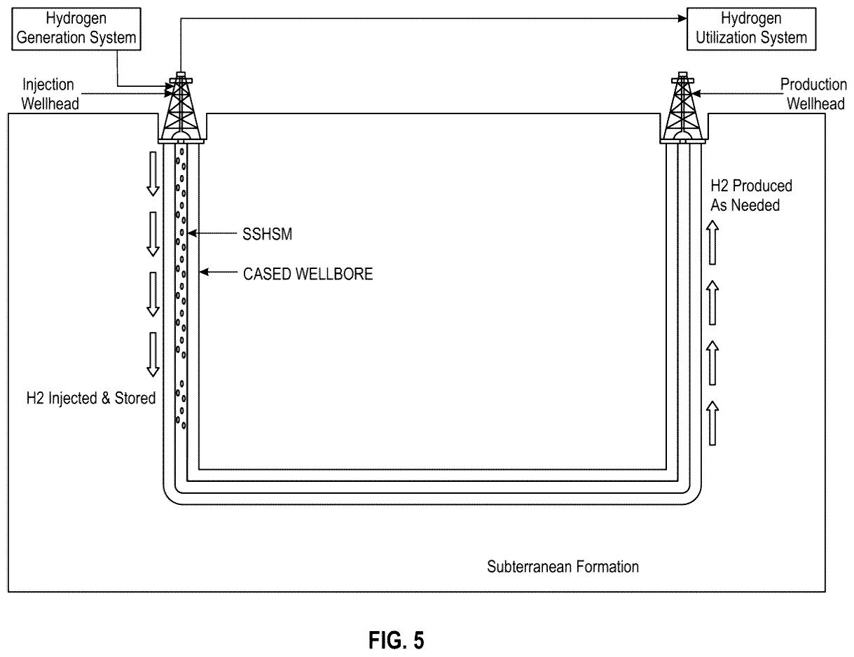

Integrated underground hydrogen storage and production systems of the present disclosure may comprise one or more underground hydrogen storage and production vessels (e.g., of the present disclosure), each fluidically connected to a hydrogen generation system via the injection wellheads and/or a hydrogen utilization system via the production wellhead. Integrated underground hydrogen storage and production systems may be designed with various wellbore geometries. FIG. 3 illustrates an integrated underground hydrogen storage and production system utilizing one or more vertical wellbores as underground hydrogen storage and production vessels, the vertical wellbores drilled at one or more shallow depths, each using a single wellhead to inject and produce hydrogen, in accordance with one embodiment. FIG. 4 illustrates one embodiment of an integrated underground hydrogen storage and production system utilizing one or more horizonal wellbores, such as L-shaped wellbores (or L-shaped directional wellbores, not shown), as underground hydrogen storage and production vessels, the horizontal wellbores drilled at one or more shallow depths, each using a single wellhead to inject and produce hydrogen, in accordance with one embodiment. For vertical wellbores or horizontal wellbores having a single surface opening (e.g., L-shaped wellbores or L-shaped directional wellbores), hydrogen may be injected and produced using the same wellhead which is disposed at or near the single surface opening. FIG. 5 illustrates one embodiment of an integrated underground hydrogen storage system utilizing one or more U-shaped wellbores (or U-shaped directional wellbores, not shown) as underground hydrogen storage vessels, further utilizing separate injection and production wellheads, each located at or near one of the two surface openings of the U-shaped wellbore, in accordance with one embodiment. However, horizontal wellbores having two surface openings are not required to have a wellhead at or near each, and may utilize a single wellhead as the injection wellhead and the production wellhead, similar to vertical wellbores. The horizontal wellbore section of any horizontal wellbore may extend several kilometers, e.g., about 10,000 ft. to about 15,000 ft., such as to connect a central hydrogen production facility to a location where hydrogen is needed for utilization, e.g., a fueling station.

Integrated underground hydrogen storage and production systems may utilize wellbores disposed within various types of subterranean formations, whether such wellbores are located close to hydrogen generation systems and/or hydrogen utilization systems. Integrated hydrogen storage systems of the present disclosure may even leverage existing wellbore infrastructure, reducing the need for extensive new storage facilities and associated costs. Overall, using an integrated system for hydrogen storage in a cased wellbore ensures safe, abundant, and flexible storage capabilities, supporting the widespread adoption and utilization of hydrogen as a clean energy resource.

### Hydrogen Generation Systems

Integrated underground hydrogen storage and production systems may comprise various hydrogen generation systems capable of generating hydrogen, such as steam methane reforming, electrolysis, or biomass conversion. Generated hydrogen may be further moved to a compressor to form a compressed hydrogen gas.

### Hydrogen Utilization Systems

Integrated underground hydrogen storage and production systems may comprise various hydrogen utilization systems capable of directing hydrogen for use in power generation, transportation, or industrial processes through technologies such as fuel cells or hydrogen-driven engines. Hydrogen utilization systems ensure a seamless and sustainable flow of hydrogen throughout the entire life cycle, enabling the realization of a clean and versatile energy economy.

### Hydrogen Compression Systems or Hydrogen Liquefaction Systems

Integrated underground hydrogen storage and production systems may further include a hydrogen compression system or a hydrogen liquefaction system for generating compressed hydrogen gas or liquid hydrogen: from hydrogen generated by the hydrogen generation system and for sending the compressed hydrogen gas or liquid hydrogen to the injection wellhead; and/or from hydrogen produced from the production wellhead and for sending the compressed hydrogen gas or liquid hydrogen to the hydrogen utilization system.

### Methods of Underground Hydrogen Storage and Production

Methods of the present disclosure may comprise injecting hydrogen into the cased wellbore of an underground hydrogen storage and production vessel of the present disclosure via an injection wellhead thereof; storing the hydrogen within the underground hydrogen storage and production vessel; and producing the hydrogen from the underground hydrogen storage and production vessel via a production wellhead thereof. Methods of the present disclosure may further comprise receiving hydrogen via the injection wellbore; and/or sending the produced hydrogen from the production wellhead.

Methods may further comprise generating hydrogen via a hydrogen generation system and directly or indirectly sending the generated hydrogen directly or indirectly to the injection wellhead; and/or sending hydrogen produced from the production wellhead directly or indirectly to a hydrogen utilization system and utilizing the received hydrogen as a fuel or to generate electricity. Sending hydrogen indirectly to the injection wellhead may comprise: sending hydrogen gas to a hydrogen compression system or a hydrogen liquefaction system; generating compressed hydrogen gas or liquid hydrogen therefrom; and sending the compressed hydrogen gas or liquid hydrogen to the injection wellhead. Sending hydrogen indirectly to a hydrogen utilization system may comprise: sending produced hydrogen from the production wellhead to a hydrogen compression system or a hydrogen liquefaction system; generating compressed hydrogen gas or liquid hydrogen therefrom; and sending the compressed hydrogen gas or liquid hydrogen to the hydrogen utilization system.

Methods may further comprise preparing the underground hydrogen storage and production vessel. Preparing the underground hydrogen storage and production vessel may comprise preparing a new cased wellbore, decommissioning an existent cased wellbore, or any combination thereof. Preparing the underground hydrogen storage and production vessel may include drilling a new vertical wellbore, directional wellbore, or L-shaped wellbore to intersect an existent decommissioned vertical wellbore, directional wellbore, or L-shaped wellbore to make a U-shaped wellbore. Preparing the underground hydrogen storage and production vessel may include drilling a new horizontal wellbore section to extend an existent decommissioned vertical wellbore, directional wellbore, or L-shaped wellbore. Preparing the underground hydrogen storage and production vessel may include drilling a new horizontal wellbore section between two existent vertical wellbores, directional wellbores, or any combination thereof, to form a U-shaped wellbore.

Preparing the underground hydrogen storage and production vessel may further comprise sealing the underground hydrogen storage and production vessel to isolate the cased wellbore from the subterranean formation. Sealing the underground hydrogen storage and production vessel may comprise disposing the one or more seals within one or more openings of the underground hydrogen storage and production vessel and/or the one or more portions of the subterranean formation in fluidic communication with one or more openings of the casing.

Disposing the one or more seals within the one or more openings of the underground hydrogen storage and production vessel may comprise disposing one or more mechanical or chemical seals as described herein in the annulus between the wellbore wall and the outer surface of the casing. Disposing the seal in the annulus may be performed after drilling of the wellbore. The chemical seal may comprise a cement, a nanosilica gel, or the like, as described herein, e.g., formed by injection of a liquid comprising a precursor material into the annulus, e.g., via the opening at the bottom of a vertical wellbore, or via the opening at the end of a horizontal wellbore section (i.e., at the casing toe). In certain embodiments, the seal in the annulus is a cement sheath formed, e.g., by a liquid comprising a cement precursor material.

Disposing the one or more seals within the one or more openings of the casing may comprise placement of one or more mechanical or chemical seals as described herein within one or more perforations in the casing. Disposing the one or more seals within the one or more openings of the casing may comprise placement of one or more mechanical or chemical seals as described herein across the wellbore, such as at the bottom of a vertical wellbore or at the end of a horizontal wellbore section (i.e., at the casing toe). Disposing the one or more seals within the one or more perforations and/or across the wellbore may be performed during decommissioning of the wellbore. The chemical seal may comprise a cement, a nanosilica gel, or the like, as described herein, e.g., formed by injection of a liquid comprising a precursor material into the one or more perforations and/or across the wellbore.

Disposing the one or more seals within the one or more portions of the subterranean formation in fluidic communication with one or more openings of the casing may be performed during decommissioning of an existing wellbore. Disposing the one or more seals within the one or more portions of the subterranean formation in fluidic communication with one or more openings of the casing may comprise injecting a fluid comprising a precursor material as described herein into the subterranean formation, such as a cement, a nanosilica gel, or the like, as described herein, via the one or more perforations of a wellbore and/or via the bottom of a vertical wellbore or the end of a horizontal wellbore section (i.e., at the casing toe).

Preparing the underground hydrogen storage and production vessel may further comprise disposing the at least one SSHSM in the casing. The method of introducing and positioning SSHSMs within a casing depends on the material's physical properties and the operational requirements of the storage system. The choice between powder, pellet, fiber, or composite forms of SSHSMs affects the selection of method of introducing the SSHSM into the casing. Hydrogen flow dynamics affects the choice of the method of SSHSM introduction, as efficient hydrogen charging and discharging cycles is essential. Structural integrity of the wellbore is a critical consideration, and the weight and distribution of SSHSMs should not compromise the mechanical stability of the casing or wellbore. Careful consideration of these factors ensures efficient hydrogen storage and retrieval while maintaining the integrity of the underground storage vessel.

In preparing underground hydrogen storage and production vessels, the method of introducing SSHSMs into the casing is crucial for optimal performance. The selection of the introduction method depends on the physical form of the SSHSMs and the specific design requirements of the storage system. Methods of introducing SSHSMs may include gravity feeding, pneumatic conveyance, slurry injection, and/or gel or low-viscosity fluid placement. Gravity feeding is particularly suitable for SSHSMs in powder or granular form. The gravity feeding process comprises pouring SSHSMs into the casing from the surface, relying on gravity to distribute them. Gravity feeding requires care to ensure even distribution of SSHSMs, which can be challenging, and vibration or mechanical agitation may be employed to facilitate uniform placement. Pneumatic conveying is particularly suitable for powdered SSHSMs. The pneumatic conveying process comprises using compressed air or inert gas to transport the material through pipes into the casing. Pneumatic conveying controls dust generation and allows for controlled placement, but requires equipment to manage airflow and pressure. Slurry injection is particularly suitable for SSHSMs that can be suspended in a liquid medium. The slurry injection process comprises mixing of the SSHSMs with a carrier fluid to create a slurry, which is then pumped into the casing. The carrier fluid should be non-reactive with both the SSHSM and hydrogen; post-injection drying or curing may be necessary to remove the fluid. Gel/low-viscosity fluid placement is particularly suitable for SSHSMs that can be dispersed in gels or low-viscosity fluids. The gel/low-viscosity fluid placement process comprises injecting a mixture of the SSHSMs and a gel or low-viscosity fluid into the casing, where the mixture solidifies or sets in place. The setting time and final properties of the gel/low-viscosity fluid must be compatible with operational requirements.

Methods of positioning of SSHSMs within the casing may comprise full-length filling, annular placement, and/or segmented installation. The full-length filling process comprises filling the entire length and diameter of the casing with the SSHSMs, ensuring maximum storage capacity. The full-length filling process requires careful planning to manage the weight and ensure structural integrity of the wellbore. The annular placement process comprises positioning the SSHSMs in an annular space between the interior surface of the casing and a central conduit disposed within the interior of the casing. The annular placement process allows for the unimpeded flow of hydrogen through the central conduit during injection and withdrawal. The segmented installation process comprises placing the SSHSMs at specific intervals along the casing, with gaps to facilitate monitoring or flow control. The segmented installation process enables targeted placement in zones with optimal storage conditions or structural support.

### Example Embodiments

The present disclosure is further directed to the following non-limiting embodiments.

Embodiment 1. An underground hydrogen storage and production vessel comprising: a cased wellbore disposed within a subterranean formation and capable of storing hydrogen; one or more seals capable of fluidically isolating the cased wellbore from the subterranean formation; an injection wellhead in fluid communication with the cased wellbore and capable of receiving hydrogen and injecting the received hydrogen into the cased wellbore; and a production wellhead in fluid communication with the cased wellbore and capable of producing the stored hydrogen from the cased wellbore, wherein the production wellhead and the injection wellhead are the same wellhead or different wellheads, wherein the cased wellbore comprises: a wellbore comprising a wellbore wall and a surface opening; a casing disposed within the wellbore, defining an interior, and comprising an exterior surface and an interior surface; and at least one solid-state hydrogen storage material disposed in the interior of the casing, capable of reversibly storing the injected hydrogen, and comprising at least one material selected from the group consisting of metal hydrides, metal-organic frameworks, and any combination thereof.

Embodiment 2. The underground hydrogen storage and production vessel of Embodiment 1, wherein the at least one solid-state hydrogen storage material comprises at least one material in the form of a powder, a pellet, a single crystal, a thin film, a fiber, a monolith, a composite, or any combination thereof.

Embodiment 3. The underground hydrogen storage and production vessel of Embodiment 1 or Embodiment 2, wherein the metal hydrides comprise metal borohydrides, nanoporous metal hydrides, or any combination thereof; and/or wherein the metal-organic frameworks (MOFs) comprise defective MOFs, catalyst-doped MOFs, or any combination thereof.

Embodiment 4. The underground hydrogen storage and production vessel of any one of Embodiments 1-3, wherein the casing comprises: at least one hydrogen-resistant material; a coating comprising at least one hydrogen-resistant material; and/or an internal liner comprising at least one hydrogen-resistant material, and wherein the at least one hydrogen-resistant material comprises a thermoplastic polymer, a fiber-reinforced composite thereof, a metal alloy, or any combination thereof.

Embodiment 5. The underground hydrogen storage and production vessel of any one of Embodiments 1-4, wherein the one or more seals are disposed at one or more openings of the underground hydrogen storage and production vessel, and/or within portions of the subterranean formation adjacent to the underground hydrogen storage and production vessel.

Embodiment 6. The underground hydrogen storage and production vessel of any one of Embodiments 1-5, wherein the one or more seals comprise at least one hydrogen-resistant material selected from the group consisting of cement, a nanosilica gel, or any combination thereof.

Embodiment 7. The underground hydrogen storage and production vessel of any one of Embodiments 1-6, wherein the wellbore is a vertical wellbore, an L-shaped wellbore, a U-shaped wellbore, or a directional wellbore thereof.

Embodiment 8. An integrated underground hydrogen storage and production system comprising: one or more underground hydrogen storage and production vessels, each comprising: a cased wellbore disposed within a subterranean formation and capable of storing hydrogen; one or more seals capable of fluidically isolating the cased wellbore from the subterranean formation; an injection wellhead in fluid communication with the cased wellbore and capable of receiving hydrogen and injecting the received hydrogen into the cased wellbore; and a production wellhead in fluid communication with the cased wellbore and capable of producing the stored hydrogen from the cased wellbore, wherein the production wellhead is a same or different wellhead as the injection wellhead, wherein the cased wellbore comprises: a wellbore comprising a wellbore wall and a surface opening; a casing disposed within the wellbore, defining an interior and comprising an exterior surface and an interior surface; and at least one solid-state hydrogen storage material disposed in the interior of the casing, capable of reversibly storing the injected hydrogen, and comprising at least one material selected from the group consisting of metal hydrides, metal-organic frameworks, and any combination thereof; one or more hydrogen generation systems, each capable of generating hydrogen and sending the generated hydrogen directly or indirectly to at least one of the injection wellheads of the one or more underground hydrogen storage and production vessels; and one or more hydrogen utilization systems, each capable of directly or indirectly receiving hydrogen produced from at least one of the production wellheads of the one or more underground hydrogen storage and production vessels and utilizing the received hydrogen as a fuel or to generate electricity.

Embodiment 9. The integrated underground hydrogen storage and production system of Embodiment 8, further comprising one or more hydrogen compression systems and/or one or more hydrogen liquefaction systems, each capable of: receiving hydrogen generated by at least one of the one or more hydrogen generation systems, generating compressed hydrogen gas or liquid hydrogen therefrom, and sending the compressed hydrogen gas or liquid hydrogen to at least one of the one or more injection wellheads of the one or more underground hydrogen storage and production vessels; and/or receiving hydrogen produced from at least one of the production wellheads of the one or more underground hydrogen storage and production vessels, generating compressed hydrogen gas or liquid hydrogen therefrom, and sending the compressed hydrogen gas or liquid hydrogen to at least one of the one or more hydrogen utilization systems.

Embodiment 10. A method of underground hydrogen storage and production, comprising: injecting hydrogen into an underground hydrogen storage and production vessel via an injection wellhead thereof; storing the injected hydrogen in the underground hydrogen storage and production vessel; and producing the stored hydrogen from the underground hydrogen storage and production vessel via a production wellhead thereof; wherein the underground hydrogen storage and production vessel comprises: a cased wellbore disposed within a subterranean formation and capable of storing hydrogen; one or more seals capable of fluidically isolating the cased wellbore from the subterranean formation; the injection wellhead in fluid communication with the cased wellbore and capable of receiving hydrogen and injecting the received hydrogen into the cased wellbore; and the production wellhead in fluid communication with the cased wellbore and capable of producing the stored hydrogen from the cased wellbore, wherein the production wellhead is a same or different wellhead as the injection wellhead; and wherein the cased wellbore comprises: a wellbore comprising a wellbore wall and a surface opening; a casing disposed within the wellbore, defining an interior and having an exterior surface and an interior surface; and at least one solid-state hydrogen storage material disposed in the interior of the casing, capable of reversibly storing the injected hydrogen, and comprising at least one material selected from the group consisting of metal hydrides, metal-organic frameworks, and any combination thereof.

Embodiment 11. The method of Embodiment 10, further comprising: receiving hydrogen at the injection wellhead; and/or delivering the produced hydrogen from the production wellhead.

Embodiment 12. The method of Embodiment 11, wherein receiving hydrogen at the injection wellhead comprises: generating hydrogen via a hydrogen generation system; and sending the generated hydrogen directly or indirectly to the injection wellhead; and/or wherein delivering the produced hydrogen from the production wellhead comprises: sending the produced hydrogen from the production wellhead directly or indirectly to a hydrogen utilization system; and utilizing the received hydrogen as a fuel or to generate electricity.

Embodiment 13. The method of Embodiment 12, wherein: sending the generated hydrogen indirectly to the injection wellhead comprises: sending the generated hydrogen to a hydrogen compression system or a hydrogen liquefaction system; generating compressed hydrogen gas or liquid hydrogen therefrom; and sending the compressed hydrogen gas or liquid hydrogen to the injection wellhead; and/or sending the produced hydrogen from the production wellhead indirectly to a hydrogen utilization system comprises: sending the produced hydrogen from the production wellhead to a hydrogen compression system or a hydrogen liquefaction system; generating compressed hydrogen gas or liquid hydrogen therefrom; and sending the compressed hydrogen gas or liquid hydrogen to the hydrogen utilization system.

Embodiment 14. The method of any one of Embodiments 10-13, further comprising preparing the underground hydrogen storage and production vessel by preparing a new cased wellbore and/or by decommissioning an existing cased wellbore.

Embodiment 15. The method of any one of Embodiments 10-14, wherein the at least one solid-state hydrogen storage material comprises at least one material in the form of a powder, a pellet, a single crystal, a thin film, a fiber, a monolith, a composite, or any combination thereof.

Embodiment 16. The method of any one of Embodiments 10-15, wherein the metal hydrides comprise metal borohydrides, nanoporous metal hydrides, or any combination thereof; and/or wherein the metal-organic frameworks (MOFs) comprise defective MOFs, catalyst-doped MOFs, or any combination thereof.

Embodiment 17. The method of any one of Embodiments 10-16, wherein the casing comprises: at least one hydrogen-resistant material; a coating comprising at least one hydrogen-resistant material; and/or an internal liner comprising at least one hydrogen-resistant material, and wherein the at least one hydrogen-resistant material comprises a thermoplastic polymer, a fiber-reinforced composite thereof, a metal alloy, or any combination thereof.

Embodiment 18. The method of any one of Embodiments 10-17, wherein the one or more seals are disposed at one or more openings of the underground hydrogen storage and production vessel, and/or within portions of the subterranean formation adjacent to the underground hydrogen storage and production vessel.

Embodiment 19. The method of any one of Embodiments 10-18, wherein the one or more seals comprise at least one hydrogen-resistant material selected from the group consisting of cement, a nanosilica gel, or any combination thereof.

Embodiment 20. The method of any one of Embodiments 10-19, wherein the wellbore is a vertical wellbore, an L-shaped wellbore, a U-shaped wellbore, or a directional wellbore thereof.

What is claimed is:

1. An underground hydrogen storage and production vessel, comprising:
a cased wellbore disposed within a subterranean formation and capable of storing hydrogen;
one or more seals capable of fluidically isolating the cased wellbore from the subterranean formation;
an injection wellhead in fluid communication with the cased wellbore and capable of receiving hydrogen and injecting the received hydrogen into the cased wellbore; and
a production wellhead in fluid communication with the cased wellbore and capable of producing the stored hydrogen from the cased wellbore, wherein the production wellhead is a same or different wellhead as the injection wellhead,
wherein the cased wellbore comprises:
a wellbore comprising a wellbore wall and a surface opening;
a casing disposed within the wellbore, defining an interior, and comprising an exterior surface and an interior surface; and
at least one solid-state hydrogen storage material disposed in the interior of the casing, capable of reversibly storing the injected hydrogen, and comprising at least one material selected from the group consisting of metal hydrides, metal-organic frameworks, and any combination thereof.

2. The underground hydrogen storage and production vessel of claim 1, wherein the at least one solid-state hydrogen storage material comprises at least one material in the form of a powder, a pellet, a single crystal, a thin film, a fiber, a monolith, a composite, or any combination thereof.

3. The underground hydrogen storage and production vessel of claim 1, wherein the metal hydrides comprise metal borohydrides, nanoporous metal hydrides, or any combination thereof; and/or wherein the metal-organic frameworks (MOFs) comprise defective MOFs, catalyst-doped MOFs, or any combination thereof.

4. The underground hydrogen storage and production vessel of claim 1, wherein the casing comprises:
at least one hydrogen-resistant material;
a coating comprising at least one hydrogen-resistant material; and/or
an internal liner comprising at least one hydrogen-resistant material, and
wherein the at least one hydrogen-resistant material comprises a thermoplastic polymer, a fiber-reinforced composite thereof, a metal alloy, or any combination thereof.

5. The underground hydrogen storage and production vessel of claim 1, wherein the one or more seals are disposed at one or more openings of the underground hydrogen storage and production vessel, and/or within portions of the subterranean formation adjacent to the underground hydrogen storage and production vessel.

6. The underground hydrogen storage and production vessel of claim 1, wherein the one or more seals comprise at least one hydrogen-resistant material selected from the group consisting of cement, a nanosilica gel, or any combination thereof.

7. The underground hydrogen storage and production vessel of claim 1, wherein the wellbore is a vertical wellbore, an L-shaped wellbore, a U-shaped wellbore, or a directional wellbore thereof.

8. An integrated underground hydrogen storage and production system comprising:
one or more underground hydrogen storage and production vessels, each comprising:
a cased wellbore disposed within a subterranean formation and capable of storing hydrogen;
one or more seals capable of fluidically isolating the cased wellbore from the subterranean formation;
an injection wellhead in fluid communication with the cased wellbore and capable of receiving hydrogen and injecting the received hydrogen into the cased wellbore; and
a production wellhead in fluid communication with the cased wellbore and capable of producing the stored hydrogen from the cased wellbore, wherein the production wellhead is a same or different wellhead as the injection wellhead,
wherein the cased wellbore comprises:
a wellbore comprising a wellbore wall and a surface opening;
a casing disposed within the wellbore, defining an interior and comprising an exterior surface and an interior surface; and
at least one solid-state hydrogen storage material disposed in the interior of the casing, capable of reversibly storing the injected hydrogen, and comprising at least one material selected from the group consisting of metal hydrides, metal-organic frameworks, and any combination thereof;
one or more hydrogen generation systems, each capable of generating hydrogen and sending the generated hydrogen directly or indirectly to at least one of the injection wellheads of the one or more underground hydrogen storage and production vessels; and
one or more hydrogen utilization systems, each capable of directly or indirectly receiving hydrogen produced from at least one of the production wellheads of the one or more underground hydrogen storage and production vessels and utilizing the received hydrogen as a fuel or to generate electricity.

9. The integrated underground hydrogen storage and production system of claim 8, further comprising one or more hydrogen compression systems and/or one or more hydrogen liquefaction systems, each capable of:
receiving hydrogen generated by at least one of the one or more hydrogen generation systems, generating compressed hydrogen gas or liquid hydrogen therefrom, and sending the compressed hydrogen gas or liquid hydrogen to at least one of the one or more injection wellheads of the one or more underground hydrogen storage and production vessels; and/or
receiving hydrogen produced from at least one of the production wellheads of the one or more underground hydrogen storage and production vessels, generating compressed hydrogen gas or liquid hydrogen therefrom, and sending the compressed hydrogen gas or liquid hydrogen to at least one of the one or more hydrogen utilization systems.

10. A method of underground hydrogen storage and production, comprising:
injecting hydrogen into an underground hydrogen storage and production vessel via an injection wellhead thereof;
storing the injected hydrogen in the underground hydrogen storage and production vessel; and
producing the stored hydrogen from the underground hydrogen storage and production vessel via a production wellhead thereof;
wherein the underground hydrogen storage and production vessel comprises;
a cased wellbore disposed within a subterranean formation and capable of storing hydrogen;
one or more seals capable of fluidically isolating the cased wellbore from the subterranean formation;
the injection wellhead in fluid communication with the cased wellbore and capable of receiving hydrogen and injecting the received hydrogen into the cased wellbore; and
the production wellhead in fluid communication with the cased wellbore and capable of producing the stored hydrogen from the cased wellbore, wherein the production wellhead is a same or different wellhead as the injection wellhead; and
wherein the cased wellbore comprises:
a wellbore comprising a wellbore wall and a surface opening;
a casing disposed within the wellbore, defining an interior and having an exterior surface and an interior surface; and
at least one solid-state hydrogen storage material disposed in the interior of the casing, capable of reversibly storing the injected hydrogen, and comprising at least one material selected from the group consisting of metal hydrides, metal-organic frameworks, and any combination thereof.

11. The method of claim 10, further comprising:
receiving hydrogen at the injection wellhead; and/or
delivering the produced hydrogen from the production wellhead.

12. The method of claim 11, wherein receiving hydrogen at the injection wellhead comprises:
generating hydrogen via a hydrogen generation system; and
sending the generated hydrogen directly or indirectly to the injection wellhead; and/or
wherein delivering the produced hydrogen from the production wellhead comprises:
sending the produced hydrogen from the production wellhead directly or indirectly to a hydrogen utilization system; and
utilizing the received hydrogen as a fuel or to generate electricity.

13. The method of claim 12, wherein:
sending the generated hydrogen indirectly to the injection wellhead comprises:
sending the generated hydrogen to a hydrogen compression system or a hydrogen liquefaction system;
generating compressed hydrogen gas or liquid hydrogen therefrom; and
sending the compressed hydrogen gas or liquid hydrogen to the injection wellhead; and/or
sending the produced hydrogen from the production wellhead indirectly to a hydrogen utilization system comprises:
sending the produced hydrogen from the production wellhead to a hydrogen compression system or a hydrogen liquefaction system;
generating compressed hydrogen gas or liquid hydrogen therefrom; and
sending the compressed hydrogen gas or liquid hydrogen to the hydrogen utilization system.

14. The method of claim 10, further comprising preparing the underground hydrogen storage and production vessel by preparing a new cased wellbore and/or by decommissioning an existing cased wellbore.

15. The method of claim 10, wherein the at least one solid-state hydrogen storage material comprises at least one material in the form of a powder, a pellet, a single crystal, a thin film, a fiber, a monolith, a composite, or any combination thereof.

16. The method of claim 10, wherein the metal hydrides comprise metal borohydrides, nanoporous metal hydrides, or any combination thereof; and/or wherein the metal-organic frameworks (MOFs) comprise defective MOFs, catalyst-doped MOFs, or any combination thereof.

17. The method of claim 14, wherein the casing comprises:
at least one hydrogen-resistant material;
a coating comprising at least one hydrogen-resistant material; and/or
an internal liner comprising at least one hydrogen-resistant material, and
wherein the at least one hydrogen-resistant material comprises a thermoplastic polymer, a fiber-reinforced composite thereof, a metal alloy, or any combination thereof.

18. The method of claim 14, wherein the one or more seals are disposed at one or more openings of the underground hydrogen storage and production vessel, and/or within portions of the subterranean formation adjacent to the underground hydrogen storage and production vessel.

19. The method of claim 14, wherein the one or more seals comprise at least one hydrogen-resistant material selected from the group consisting of cement, a nanosilica gel, or any combination thereof.

20. The method of claim 10, wherein the wellbore is a vertical wellbore, an L-shaped wellbore, a U-shaped wellbore, or a directional wellbore thereof.
